(19) United States
(12) Patent Application Publication
(10) Pub. No.: US 2025/0220326 A1
(43) Pub. Date: Jul. 3, 2025

(54) SYSTEM AND METHOD TO EXTEND OPTICAL CHANNELS FOR TRANSIENT- RESILIENT NETWORK OPERATION

(71) Applicant: Infinera Operations, LP, Wilmington, DE (US)

(72) Inventors: João Manuel Ferreira Pedro, Lisbon (PT); António Miguel Barata da Eira, Amadora (PT)

(21) Appl. No.: 18/401,626

(22) Filed: Dec. 31, 2023

(51) Int. Cl. H04Q 11/00

(52) U.S. Cl. CPC H04Q 11/0062; H04Q 2011/0086

(57) ABSTRACT

The inventive system and method of the present invention helps improve transient resiliency of optical network operation by creating one or more optical channel extensions in the network, based on one or more optical data channels. In certain example embodiments, a given provisioned path node may be configured for example to, in addition to expressing and/or dropping a corresponding provisioned optical data channel, also selectively express the provisioned optical data channel through one or more egresses of the provisioned path node that is/are not otherwise employed to establish the provisioned optical data channel path. The presence of such optical channel extension(s) in the optical network can for example serve, in a practical, cost-effective manner, to improve the transient resiliency of one or more downstream links in the network along which one or more of such optical channel extension(s) communicate.

### TECHNICAL FIELD

The present disclosure relates generally to optical networks and management of optical networks, and more specifically to a system and method for providing transient-resilient transmissions in an optical network.

### BACKGROUND

Optical wavelength-division multiplexed (WDM) networks typically comprise links-sometimes also called segments—that connect network node pairs using fiber optic cable(s) for example, so as to establish the network. The resulting network may for example form a ring or a mesh. Interruptions (e.g., cuts, breaks, disconnections, etc.) and/or other events (e.g., power surges, etc.) may disrupt or otherwise impact operation of the optical network. Impactful events may occur for example at one or more links, or at one or more nodes, and/or any combination thereof. A transient trigger event is an event that gives rise to one or more transients at one or more optical network locations downstream of the event. A transient is a resulting fluctuation, variation, or other change in the power-over-frequency or spectral resource profile (for simplicity, hereinafter “power profile”) at a given optical network location. Typically, among the more challenging of transients from an ongoing network operations perspective is for example a meaningful change in power profile that is relatively sudden, momentary, and/or unmitigated, particularly in relation to those pre-existing optical data channel resources of the power profile that survive the transient trigger event. A given unmitigated transient might be significant enough to itself cause traffic loss or otherwise adversely impact optical transmission performance of one or more surviving optical data channels communicating downstream of the transient trigger event.

### SUMMARY OF THE DISCLOSURE

One of the factors that can inhibit robust operation of WDM networks, even when protection/restoration mechanisms are in place, is the dynamic response of optical network components, such as for example optical amplifiers having a response that is a function of the amplifier's input power profile. Take for instance a fiber cut or another WDM network-impacting event that results in one or more optical data channels traversing the network suddenly no longer being present at one or more network links downstream of such network event. This is an example of a transient trigger event, insofar as this resulting optical data channel absence in a given downstream link alters the power profile of such downstream link. This change in power profile, or transient, may adversely impact for example the fiber response of downstream links, and/or the output power response of downstream optical amplifiers, which in turn may give rise to optical communication transmission performance degradation (hereinafter also referred to as “Quality of Transmission”/“QoT” degradation) in the network. Events such as sudden, unmitigated network interruptions and power connection surges serve as possible representative, non-exclusive examples of transient triggering events.

A transient can arise in an optical network even if for example a given pre-existing (i.e., pre-existing, from the perspective of the onset of a given transient triggering event) optical data channel that belongs to such changed power profile is not altogether lost as a direct result of the event, but nevertheless is still impacted by the event in some other way so as to contribute to the power profile change. An uncontrolled turn-up of multiple new optical data channels, or a rerouting of multiple existing optical data channels, for example can also represent a transient triggering event, insofar as a relatively sudden, meaningful increase in the number of optical data channels on a given link in turn may cause the pre-existing optical data channels already present on the link to experience a resulting drop in optical power.

Quality of Transmission (QoT) degradation, as is already understood by those skilled in the pertinent art, may take many forms, including for example compromised power levels and/or timing, if not total loss, of other optical data channels that for example were already present in the now-changed power profile. Such an adverse effect on transmission performance can be even more pronounced for example in optical networks that exploit a wide spectrum window (e.g., C+L-band), due to the stronger impact of physical impairments, such as stimulated Raman scattering (SRS) for example. Hence, it is important to employ apparatus and/or methods to help mitigate the impact of transients, preferably in a practical, cost-effective manner. Prior art mitigation techniques include for example the installation of dedicated hardware (e.g., transient-suppression cards, ASE idlers) at each link to help enforce a more stable power profile for example in the event of upstream failure(s). Such prior art techniques, however, do have certain drawbacks, including for example certain drawbacks discussed later in this disclosure.

Ordinarily, a given optical data channel in a prior art WDM network for example is provisioned, using a network controller and/or management system for example, to extend between two end nodes—i.e., from a first (e.g., source) node in the network to a second (e.g. destination) node in the network through one or more network links and, if a plurality of links, through any additional intervening node(s) that serve(s) to interconnect the plurality of links along the provisioned path (i.e., the provisioned optical data channel path). As a result, the provisioned optical data channel path establishes an optical channel (i.e., the provisioned optical data channel) for optical data communications (e.g., client traffic) between the first node and the second node. These first and second nodes, and any other intervening node(s) that may also serve(s) to establish the provisioned optical data channel path, for convenience shall be hereinafter referred to as provisioned path nodes (for the given optical data channel). With respect to each of the provisioned path nodes of a given provisioned optical data channel path, each provisioned path node ingress and/or provisioned path node egress that is employed to establish the provisioned optical data channel path to enable provisioned optical data channel communications is deemed to be a part of the provisioned optical data channel path, whereas the provisioned optical data channel path shall not be deemed to include any other ingress or egress of these respective provisioned path nodes. In at least certain example embodiments, a given provisioned optical data channel path is further established by and comprises applicable local add and/or drop port(s) (of the provisioned path end nodes) that is/are employed to respectively add or drop the corresponding optical data channel.

If, in relation to the provisioned optical data channel path described by the foregoing paragraph, provisioned path node is situated at a point in the provisioned optical data channel path wherein the provisioned optical data channel path branches into a plurality of downstream links of the provisioned optical data channel path that extend in parallel from node (e.g., in a multicast or point-to-multipoint application, wherein each such downstream portion of the provisioned optical data channel path eventually ends at one or more respective path destination node(s)), then the provisioned path node is configured to express the provisioned optical data channel out of the node through a plurality of node degree egresses so as to facilitate further communication of the provisioned optical data channel along the aforementioned plurality of parallel downstream links of the provisioned optical data channel path.

Fundamentally, the inventive system and method of the present invention helps improve transient resiliency of optical network operation by creating one or more optical channel extensions in the network. For purposes of this disclosure and in relation to a given example optical data channel that is provisioned, or will be provisioned if not yet actually provisioned, in a given example optical network, a given example optical channel extension is the optical power that the given provisioned path node is or will be configured to communicate to the optical network through a given egress of the provisioned path node that is not otherwise employed to establish the provisioned optical data channel path, wherein a source of the optical power comprises the corresponding provisioned optical data channel that is received by the provisioned path node. Accordingly, a given optical channel extension that is or will be for example established and communicated from a given network node using (i.e., based on) a given optical data channel is not or will not be, by definition, communicated from the given network node along a provisioned optical data channel path that corresponds to the given optical data channel, but rather is or will be communicated from the given network node on another portion of the network that does not comprise such corresponding provisioned optical data channel path.

In certain example embodiments, a given provisioned path node may be configured to communicate a provisioned optical data channel to only one egress interface of the provisioned path node that is not otherwise employed to establish the provisioned optical data channel path, while in these and/or certain other embodiments a given provisioned path node may be configured to also and/or instead for example broadcast the provisioned optical data channel to a plurality of egress interfaces of the provisioned path node that are not otherwise employed to establish the provisioned optical data channel path. The presence of such optical channel extension(s) in the optical network can serve, in a practical, cost-effective manner, to improve the transient resiliency of a given link in the network along which one or more of such optical channel extension(s) communicate.

The foregoing summary is intended to provide a brief overview of certain subject matter described in this document, including select attributes of example embodiments of the present invention. Accordingly, it will be appreciated that the above-described features are non-limiting examples and should not be construed to narrow the scope or spirit of the subject matter described herein in any way. Other features, aspects, and advantages of the subject matter described herein will become apparent from the following disclosure, including without limitation the figures and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example optical network and related example network controller or management system;

FIG. 2 again illustrates the example optical network of FIG. 1, without depiction of the related example network controller or management system;

FIG. 3 illustrates an example optical network node, and in particular an example reconfigurable optical add-drop multiplexer (ROADM) in accordance with an example embodiment of the present invention;

FIG. 4 is another illustration of the example optical network of FIGS. 1 and 2, together with representative power profile depictions of various example optical spectral resources (e.g., one or more optical data channels) that traverse respective portions of the optical network in a representative example first network configuration;

FIG. 5 is another illustration of the example optical network of FIG. 4, but depicted in a representative example second network configuration that is in accordance with the present invention, wherein the optical network operates to further include, between two of the nodes, an example optical channel extension that corresponds in frequency to one of the example optical data channels represented in FIG. 4;

FIG. 6 is another illustration of the example optical network of FIG. 5, but now depicted in a representative example state of failure between two nodes;

FIG. 7A shows a schematic diagram representing the various nodes of the example optical network shown in FIG. 4, and the various optical data channels that are each provisioned to extend from a respective channel source node to a respective channel destination node in the representative example first optical network configuration and/or a first normal operational state;

FIG. 7B shows a schematic diagram representing the example embodiment optical network of FIG. 5 in the representative example second optical network configuration and/or a second normal operational state, including the example optical channel extension;

FIG. 7C shows another schematic diagram representing the example embodiment optical network of FIG. 6 in its depicted example state of failure, indicated by the ‘X’;

FIG. 8 is an illustration of another example optical network, together with representative power profile depictions of various example optical spectral resources (e.g., one or more optical data channels) that traverse respective portions of the optical network in a representative example first network configuration;

FIG. 9 is another illustration of the example optical network of in FIG. 8, but depicted in a representative example second network configuration that is accordance with the present invention, wherein the optical network operates to further include, between two of the nodes, two example optical channel extensions that each respectively corresponds in frequency to a respective one of two example optical data channels represented in FIG. 8;

FIG. 10 is another illustration of the example optical network of FIG. 9, but now depicted in a representative example first state of failure involving a first pair of links;

FIG. 11 is another illustration of the example optical network of FIG. 9, but now depicted in a representative example second state of failure involving a second pair of links;

FIG. 12A shows a schematic diagram representing the various nodes of the example optical network shown in FIG. 8, and the various optical data channels that are each provisioned to extend from a respective optical data channel source node to a respective optical data channel destination node in the representative example first optical network configuration and/or a first normal operational state;

FIG. 12B shows another schematic diagram representing the example optical network of FIG. 9 in the representative second state of configuration, including the example optical channel extension;

FIG. 12C shows another schematic diagram representing the example optical network of FIG. 10 in its depicted example first state of failure, wherein only optical data channels that still extend from a respective optical data channel source node and across surviving links to a respective optical data channel destination node are illustrated in this alternative form of schematic;

FIG. 12D shows another schematic diagram representing the example optical network of FIG. 11 in its depicted example second state of failure, again wherein only optical data channels that still extend from a respective optical data channel source node and across surviving links to a respective optical data channel destination node are illustrated in this alternative form of schematic;

FIG. 13 illustrates an example optical communication system configured to provide transient resilient operations in an example optical network in accordance with one or more example embodiments, including a related example communication flow;

FIG. 14 illustrates another example optical communication system configured to provide transient resilient operations in an example optical network in accordance with one or more example embodiments, including a related example communication flow;

FIG. 15 illustrates another example optical communication system configured to reactively provide transient resilient operations in an example optical network in accordance with one or more example embodiments, including a related example communication flow;

FIG. 16 illustrates an example embodiment of an apparatus, such as a network controller or management system, comprising a Path Computation Element (PCE) of the example optical communication system of FIG. 13, in accordance with one or more example embodiments;

FIG. 17 illustrates an example embodiment of an apparatus, such as a network controller or management system, comprising a PCE of the example optical communication system of FIG. 14, in accordance with one or more example embodiments;

FIG. 18 illustrates an example embodiment of an apparatus, such as a network controller or management system, comprising a PCE of the example optical communication system of FIG. 15, in accordance with one or more example embodiments;

FIG. 19 is an illustration of an example prior art optical network, together with representative power profile depictions of various example optical spectral resources (e.g., one or more optical data channels) that traverse this prior art optical network in a representative example first network state of operation;

FIG. 20 is another illustration of the example prior art optical network of FIG. 19, but now depicted in a representative example prior art state of failure between two nodes causing a loss of an optical data channel in a downstream link that, in turn, leads to one or more transmission performance-degrading transients in the fiber response of the downstream link, and/or on the output power response of one or both of the two depicted downstream optical amplifiers;

FIG. 21 illustrates a flowchart of an example method for determining optical channel extensions as a component of service provisioning, wherein optical channel extensions are determined after optical data channels corresponding to the service(s) are first determined; and

FIG. 22 illustrates a flowchart of an example method for determining optical channel extensions as a component of service provisioning, wherein optical channel extension determinations are made together with optical data channel provisioning determinations.

### DETAILED DESCRIPTION

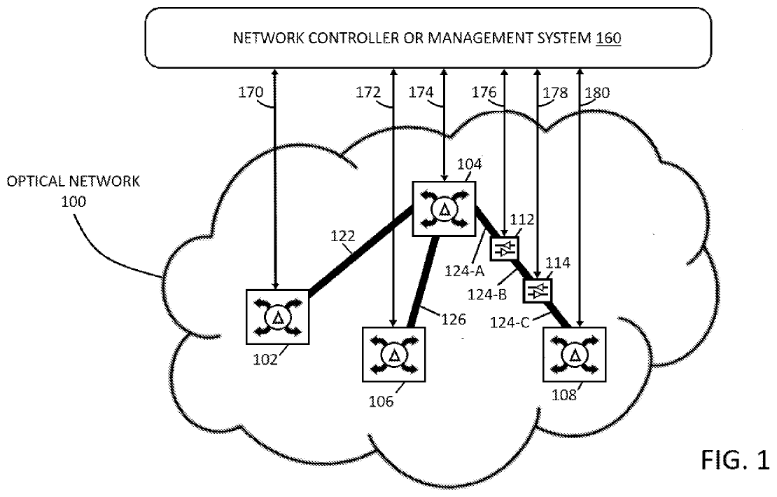

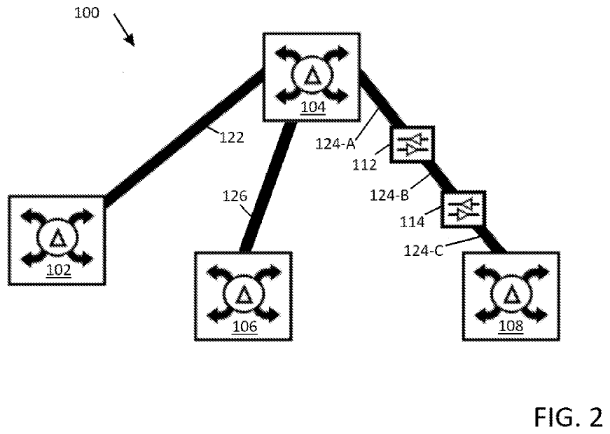

FIG. 1 illustrates an example optical network 100 and related example network controller or management system 160. Optical network 100 is a wavelength-division multiplexing (WDM) network. In this example optical network 100 configuration, network controller or management system 160 is configured to communicate with, and communicatively coupled to, optical network 100, and more particularly, network components 102, 106, 104, 162, 164 and 108, using respective network controller/management communication channels or paths 170, 172, 174, 176, 178 and 180. FIG. 2 again illustrates the example optical network 100 of FIG. 1, without depiction of the related example network controller or management system 160 so as to simplify the figures. The absence of a reference to network controller or management system 160 in certain of the figures, however, should not be interpreted to mean that the example network controller or management system 160 is any less pertinent in the context of any examples and/or example embodiments of these respective figures.

In FIGS. 1 and 2, the optical network 100 comprises nodes 102, 104, 106 and 108. Fiber optic link 122 spans node pairs 102 and 104, whereas fiber optic link 124 spans node pairs 104 and 108 and fiber optic link 126 spans node pairs 104 and 106. Each of fiber optic links 122, 124 and 126 is established by at least one optical fiber cable. Erbium-doped fiber amplifiers (EDFAs) 112 and 114 are located along the fiber optic link 124, such that a first span 124-A of fiber optic link 124 extends between node 104 and EDFA 112, a second span 124-B of fiber optic link 124 extends between EDFA 112 and EDFA 114, and a third span 124-C of fiber optic link 124 extends between EDFA 114 and node 108.

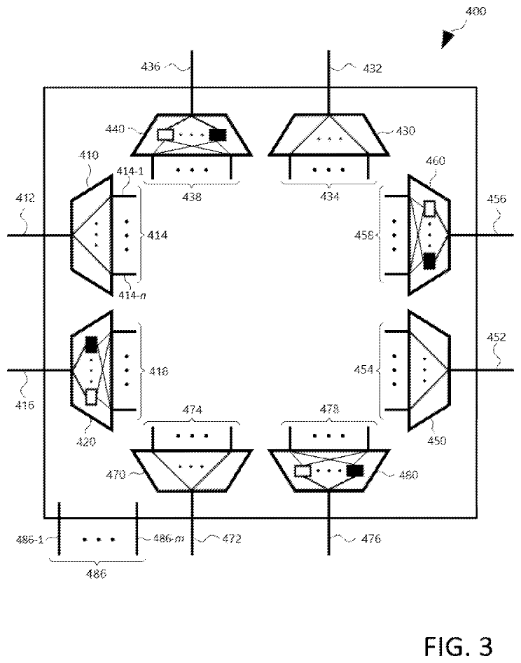

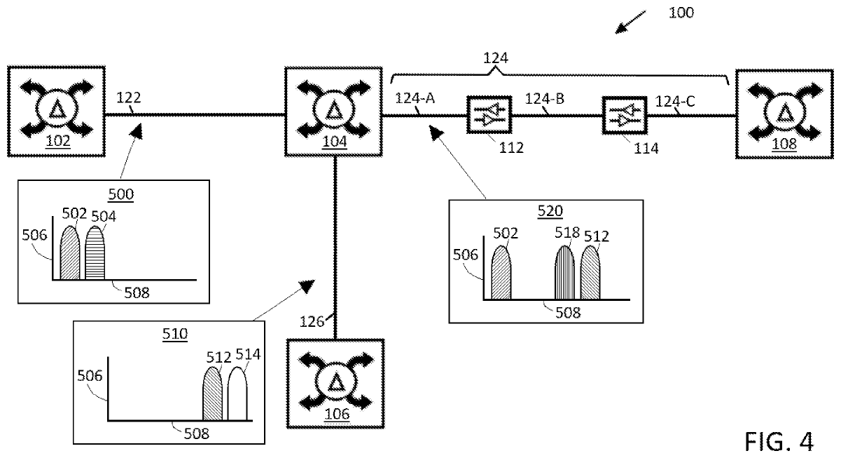

The same optical network 100 of FIGS. 1 and 2 is again represented in each of FIGS. 4, 5 and 6. Even though in FIGS. 4-6 the placement of each of the various above-described components of optical network 100, relative to other of the components, generally remains the same as FIGS. 1 and 2, FIGS. 4-6 depict that same optical network 100 in a slightly different illustration format. Note that example optical network 100 shown in each of FIGS. 4-6 is also controlled and/or managed (for convenience, hereinafter simply “managed”) by example the network controller or management system 160 shown in FIG. 1, even though it isn't depicted in FIGS. 3-6.

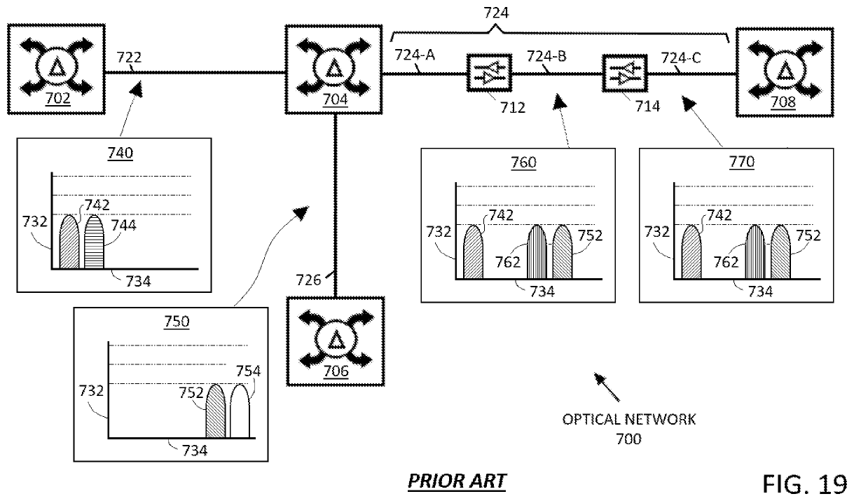

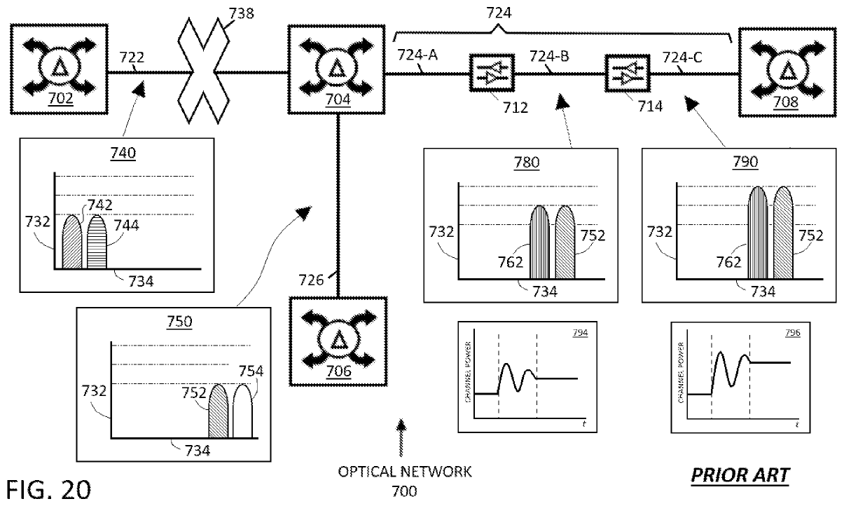

Similar to optical network 100 depicted in other Figures herein, prior art optical network 700, shown in FIGS. 19-20, comprises four nodes, namely nodes 702, 704, 706 and 708, with a fiber optic link 722 spanning node pairs 702 and 704, a fiber optic link 724 spanning node pairs 704 and 708, and a fiber optic link 726 that spans node pairs 704 and 706. Each of fiber optic links 722, 724 and 726 is established by at least one optical fiber cable. EDFAs 712 and 714 are located along the fiber optic link 724, such that a first span 724-A of fiber optic link 724 extends between node 704 and EDFA 712, a second span 724-B of fiber optic link 724 extends between EDFA 712 and EDFA 714, and a third span 724-C of fiber optic link 724 extends between EDFA 714 and node 708.

Each of nodes 702, 704, 706 and 708 can switch optical data channels between different degree ingresses and degree egresses of the respective node. In the context of this example prior art optical network 700, a given optical data channel is provisioned, using a network controller and/or management system (not shown) for example, to extend between two end nodes—i.e., from a first (e.g., source) node in the network to a second (e.g. destination) node in optical network 700 through one or more links of optical network 700 and, if a plurality of links, through intervening node 704 of optical network 700 that serves to interconnect the plurality of links along the provisioned path (i.e., the provisioned optical data channel path). As a result, the provisioned optical data channel path establishes an optical channel (i.e., the provisioned optical data channel) for optical data communications (e.g., client traffic) between the first node and the second node.

These first and second nodes, and any other intervening node (e.g., node 704, if applicable) that may also serve to establish the provisioned optical data channel path, for convenience shall be hereinafter referred to as provisioned path nodes (for the given optical data channel). With respect to each of the provisioned path nodes, each ingress and/or egress of a given provisioned path nodes that is employed to establish the provisioned optical data channel path is deemed to be a part of the provisioned optical data channel path, whereas the provisioned optical data channel path shall not be deemed to include any other ingress or egress of these provisioned path nodes that is not used to establish the provisioned optical data channel path. In at least certain example embodiments, a given provisioned optical data channel path is further established by and comprises applicable local add and/or drop port(s) (of the provisioned path end nodes) that is/are employed to respectively add or drop the corresponding optical data channel.

Each provisioned optical data channel is allocated a respective wavelength (i.e., frequency) slot (for convenience, hereinafter “wavelength”) in each of the one or more links of the provisioned optical data channel path. In general, each link in an optical WDM network with an arbitrary topology (e.g., mesh) is capable of being traversed by multiple optical data channels using a different wavelength for each data channel.

FIG. 19, for example, illustrates that optical data channel 742 is provisioned to extend from node 702 to node 708 through links 722 and 724 and node 704. Optical data channel 744 is provisioned to extend from node 702 to node 704 through link 722. Optical data channel 752 is provisioned to extend from node 706 to node 708 through links 726 and 724 and intervening node 704. Optical data channel 754 is provisioned to extend from node 706 to node 704 through link 726. Optical data channel 762 is provisioned to extend from node 704 to node 708 through link 724. Optical data channels that are provisioned to extend to node 708 also pass through EDFAs 712 and 714. Optical data channel 742 is graphically represented by graphs 740, 760 and 770 (each such graph depicting for example a respective power profile at a respective given location on each of link 722, span 724-B, and span 724-C), while optical data channel 744 is graphically depicted by graph 740. Optical data channel 752 is graphically depicted by graphs 750, 760 and 770 (graph 750 depicting for example a respective power profile at a given location on link 726), while optical data channel 754 is graphically depicted by graph 750. Optical data channel 762 is graphically depicted by graphs 760 and 770.

In each of graphs 740, 750, 760 and 770, the x-axis 734 represents frequency, while y-axis 732 represents optical power. Graph 740 graphically depicts optical data channels 742 and 744 as they exist on link 722 (i.e., a power profile at a given location on link 722). Graph 750 graphically depicts optical data channels 752 and 754 as they exist on link 726 (i.e., a power profile at a given location on link 726). Graph 760 graphically depicts optical data channels 742, 752 and 762 as they exist on link 724 for example at the output of EDFA 712 (i.e., a power profile at the upstream end of span 724-B), whereas graph 770 graphically depicts optical data channels 742, 752 and 762 as they exist on link 724 for example at the output of EDFA 714 (i.e., a power profile at the upstream end of span 724-C). FIG. 19 illustrates an example first network state of operation, which can be understood to be normal operation of prior art optical network 700. In this example illustrative state of normal operation, each of optical data channels 742, 744, 752, 754 and 762 are communicated in all of their respective links of prior art optical network 700 at what shall be, merely for purposes of simplicity in this illustrative example, assumed to be substantially the same optical power level, as demonstrated for example in relation to the y-axis 732 of each of graphs 740, 750, 760 and 770.

Of course, it will be understood that beyond this simplified illustrative example normal operation of example optical network 700, optical data channels of a given optical network more generally can be also and/or instead operated at different power levels, either purposely to attain a certain effect, or for example due to different optical data channel size. Moreover, it will also be understood for example that optical signals are typically attenuated for instance as they propagate through optical fiber and certain other optical network components, which can also result in various optical data channels operating at different power levels in different parts of the network. Furthermore, it will also be generally understood for example that optical data channel power level at a given optical network span input (also known as launch power) can be configured to slightly different levels, depending upon and according to for example the properties of a given span. Therefore, the simplified illustrative example normal operation of example optical network 700 described herein shall not in any way be interpreted to limit the types of optical networks and/or optical network operations to which the present invention may be applied. The same is true with respect to the other simplified illustrative example optical networks and optical network operations shown in the figures and described herein.

FIG. 20, by contrast, illustrates the same prior art optical network 700 depicted in FIG. 19, but now in a representative example prior art state of link failure from a transient trigger event 738 at link 722, such as a fiber cut for example. This example transient trigger event 738 causes a loss of optical data channel 742 in downstream link 724, which in turn has the effect of impacting pre-existing optical data channels 752 and 762, which survive the transient trigger event. Such impact is depicted in graphs 780 and 790 of FIG. 20. Graph 780 graphically depicts optical data channels 752 and 762 in a first state of impact as they exist on link 724 for example at the output of EDFA 712, whereas graph 790 graphically depicts optical data channels 752 and 762 in a second state of impact as they exist on link 724 for example at the output of EDFA 714. In contrast to graphs 760 and 770 of FIG. 19, each of optical data channels 752 and 762 are no longer communicated across link 724 at the same optical power level they were communicated during normal operation of prior art optical network 700, as demonstrated for example by the progressively heightened optical power levels (i.e., progressively increasing positive power offsets) of optical data channels 752 and 762 as depicted with respect to the y-axis 732 of each of graphs 780 and 790.

Optical data channels 752 and 762 are impacted in this manner at link 724 due to an example sudden loss of optical data channel 742 power at link 724 as a result of the transient trigger event. In particular, this sudden loss of power of optical data channel 742 at link 724 causes the power profile at link 724 to decrease suddenly, at least momentarily, which represents a transient on link 724 that might, if significant enough, in turn result in adverse effects and impairments on one or both the optical fiber of link 724 and on the response of EDFAs 712 and/or 714, possibly causing QoT degradation to pre-existing optical data channels 752 and 762 as now communicated across link 724. Prior art optical network 700 is at risk of transient impairments such as these for example, notwithstanding any optical network protection or restoration mechanisms that may exist at the WDM layer and/or upper layers.

With respect to the response of EDFAs 712 and 714 as shown in FIG. 20, the sudden (albeit likely momentary) decrease of overall optical power, or change in the power profile, along link 724 as a result of the absence of optical data channel 742 on link 724 operates as a transient at the respective input of each of EDFAs 712 and 714. In this example depicted in FIG. 20, EDFAs 712 and 714 are each controlled to a fixed gain, and thus will dynamically respond to this dynamic transient by maintaining an output/input gain ratio for the overall surviving signal at link 724. In doing so, EDFAs 712 and 714 alter the frequency response of surviving optical data channels 752 and 762 such that the respective outputs of each of EDFAs 712 and 714 have, following the transient trigger event, positive power offsets relative to the pre-failure state depicted in FIG. 19. These positive power offsets are depicted for example along the y-axis 732 of each of graphs 780 and 790 (FIG. 20), as compared to respective corresponding graphs 760 and 770 (FIG. 19).

The cascaded EDFAs 712 and 714 of this example prior art optical network 700 each respectively produce a dynamic output power response to the given input power profile presented along the link 724 to the respective input of the given EDFA. Accordingly, EDFAs 712 and 714 each have a dynamic output power response to the varying input power profile along link 724 that results from the transient trigger event. The response of each of EDFAs 712 and 714 therefore will tend to amplify the surviving optical data channels' collective and/or respective power offset(s) presented at the respective EDFA input. Consequently, a cascade of EDFAs along a given surviving optical path of a given prior art optical network can result in an accumulated response to the transient trigger event, particularly in links or optical paths having a relatively large number of cascaded EDFAs. From the perspective of the receiving end of a given surviving link or path comprising a cascade of EDFAs, for example, such an accumulated response can render the total power offset of a given surviving optical data channel received from the surviving link or path to be significantly different from its original pre-failure state. Such an accumulated response is demonstrated for example by the progressively positive optical power offset(s) of each of optical data channels 752 and 762 as depicted relative to the y-axis 732 of each of graphs 780 and 790.

Generally speaking, a transient trigger event circumstance that for example gives rise to a meaningfully positive power offset in one or more surviving optical data channels can for example result in increased fiber non-linearities, potentially degrading the received signal quality (i.e., higher bit error rate) of such surviving optical data channel(s) at their respective destination(s). Moreover, a transient trigger event circumstance that for example gives rise to a meaningfully negative power offset in one or more surviving optical data channels can result in optical data channel signal power received at their respective destination(s) that is below the required threshold for error-free transmission. In either of these example circumstances, the transmission performance of the surviving optical data channel(s) can be meaningfully compromised by the transient trigger event.

In example prior art optical network 700, the dynamic response of each EDFA 712 and 714 interacts with the optical fiber response of link 724, since transmission along the fiber of link 724 produces effects such as for example Simulated Raman Scattering (“SRS”), where power of optical data channels in higher frequencies is transferred to optical data channels in lower frequencies. Therefore, the sudden disappearance and/or appearance of, or other meaningful power profile change to, a portion of the WDM signal communicated across a surviving link can in turn meaningfully influence power offset(s) of surviving optical data channels, thus giving rise to transmission performance degradation. This effect can be especially pronounced for example in optical networks that exploit a wide range of the fiber bandwidth. Examples of such optical networks include C+L-band optical networks, as well as future optical networks that may exploit wider bands or additional bands, such as for example the S-band.

In view of the above it is understood that in prior art optical networks, surviving optical data channels which do not traverse a link directed affected by a transient trigger event still can be susceptible to quality of transmission (QoT) degradation, for example such that client services carried by surviving optical data channel(s) is/are adversely impacted by the occurrence of the transient trigger event. However, depending on the particular circumstances, such degradation might range from a minor degradation with no major consequence at the service level, on one hand, to the total disruption of the services carried over these surviving optical data channels, on the other hand, or something in between. Given the risk of substantial QoT degradation, however, it is important to take steps to mitigate this risk.

In the prior art, various proposals have been suggested to address the need for transient-resilient optical network operation, including for example possible development of improved optical amplification equipment and/or techniques. At least two main approaches known to the present inventors have been implemented in commercial prior art optical line systems (OLSs) in an effort to mitigate the risk of QoT degradation caused by transient trigger events. Both of these two prior art approaches used to achieve transient-resilient optical network operation rely on the deployment and use of additional equipment to help maintain a more consistent power profile in surviving links in the event of a transient trigger event, in an effort to reduce, minimize or eliminate transient-induced power difference(s) experienced by surviving optical data channel(s) on a given surviving link.

Specifically, the first of these two commercial prior art approaches contemplates deployment of an optical transient suppression card (OTSC) at a respective input of each link within a given prior art optical network that is targeted for improved transient resiliency. A given OTSC for example is used in the prior art to generate dummy optical signals (i.e., optical signals that do not carry data traffic) that are positioned at select frequency slots (e.g., distributed along the given optical resource spectrum) and continuously transmitted across the target prior art link served by the given OTSC, such that in the event of a failure for example at one or more upstream links and/or nodes, the OTSC-generated dummy optical signals remain present in the surviving target link served by the given OTSC, thereby maintaining at least a certain higher amount of overall signal power at an input of a given EDFA located along this surviving target link, as compared to the amount of overall signal power that otherwise would have been present at that given EDFA input in the absence of the OTSC. With the goal of better stabilizing the overall power profile of the surviving target link in this way, OTSCs have been deployed in the prior art in an effort to help mitigate the risk of QoT degradation on surviving links. This first approach is both static (i.e., does not depend on system reconfiguration following an occurrence of a transient trigger event) and proactive (i.e., always on), and therefore its main benefit is the speed by which the OTSC approach takes effect upon an occurrence of a transient trigger event.

The second of these two commercial prior art approaches contemplates deployment of an amplified spontaneous emission (ASE) source for each link within a given prior art optical network that is targeted for improved transient resiliency. If for example the optical node directly associated with the target link contains a ROADM, the ASE source may be situated for example at a pertinent degree egress of the ROADM that serves the target link. If a transient trigger event, such as a link or node failure for example, takes place at a link or node upstream from the target link such that for example some optical data channels are no longer present downstream of the failure, this node that is directly associated with the target link is configured to reactively change operational states in this transient trigger event circumstance such that power from the ASE source now communicates along the target link. This change of operational states may be accomplished for example using a wavelength selective switch (WSS) of the ROADM, or for example another filtering device of the optical node that serves to filter/multiplex optical signals so that they communicate along the target link following the change of operational states. The goal of the ASE approach is to help substitute for the now-missing optical data channels, using the communicated ASE noise to fill newly formed gaps in the overall power profile of the optical WDM signal communicated along the surviving, target link. As a result, ideally the scattering effects are more stabilized and the input optical signal power at a given EDFA along the surviving, target link is maintained at level(s) similar to those level(s) that existed on the target link prior to the transient trigger event, thereby mitigating against QoT degradation that might otherwise result from transients. This ASE approach is generally understood to be more spectrally efficient than the OTSC approach, insofar as with the ASE approach the only additional optical spectrum resources that are deployed are those optical data channels that are no longer present in the target link as a result of the upstream failure. Moreover, such additional optical spectrum resources are deployed only in the event of a transient trigger event.

Despite their benefits, however, each of the foregoing two commercial prior art approaches can have its drawbacks. These drawbacks may include for example the need to deploy and operate additional equipment—for example at potentially hundreds of nodes in a large network, which in turn can increase network equipment deployment, maintenance and replacement costs, network equipment power consumption, and/or consume valuable network equipment footprint and/or other resources that may be limited. Another drawback of at least the OTSC approach is that it consumes valuable spectrum resources, including during normal network operation, rendering the approach spectrally inefficient insofar as it decreases the amount of spectrum available for optical data communications (e.g., client services).

Moreover, despite the increased spectral efficiency of the alternative ASE approach, the ASE approach nevertheless is a reactive solution that presents a risk of reaction delay, insofar as the interval of time that is necessary to both identify the need for the node to react to a transient trigger event, and for the node to in turn effect a change in operational state so as to communicate the ASE noise, might be long enough so as to still present an opportunity and risk that at least an interim, short-term power transient could meaningfully degrade QoT on the target link, at least momentarily.

The present invention, by contrast, provides for transient-resilient optical network operation in a more practical and cost-effective manner. The inventive system and method of the present invention helps improve transient resiliency of optical network operation by creating one or more optical channel extensions in the network. For example, in relation to a given example optical data channel that is or will be provisioned in a given example optical network to be received by a given example provisioned path node, a given optical channel extension is the optical power that the given provisioned path node is or will be configured to communicate to the optical network through a given one or more egresses of the provisioned path node that is/are not otherwise employed to establish the provisioned optical data channel path, wherein a source of the optical power comprises the corresponding provisioned optical data channel that is received by the provisioned path node.

In one or more example embodiments of the present invention, a given provisioned path node may be configured to communicate a provisioned optical data channel to only one egress of the provisioned path node that is not otherwise employed to establish the provisioned optical data channel path, while in these and/or certain other embodiments a given provisioned path node may be configured to also and/or instead for example broadcast the provisioned optical data channel to a plurality of egress interfaces of the provisioned path node that are not otherwise employed to establish the provisioned optical data channel path.

The presence of such optical channel extension(s) in the optical network can serve, in a practical, cost-effective manner, to improve the transient resiliency of a given link in the network along which one or more of such optical channel extension(s) communicate. The present invention can be employed for example as a stand-alone transient resiliency solution for a given optical network, or in combination with other transient-resilient solutions.

In one or more example embodiments of the present invention, a given provisioned path node may be configured to communicate a provisioned optical data channel to only one egress of the provisioned path node that is not otherwise employed to establish the provisioned optical data channel path.

In one or more example embodiments of the present invention, a given provisioned path node may be configured to broadcast the provisioned optical data channel to a plurality of egress interfaces of the provisioned path node that are not otherwise employed to establish the provisioned optical data channel path.

In this regard, at least certain of these example embodiments may accomplish such communication of one or more optical channel extensions from a given node for example by leveraging the broadcast capability inherent to the broadcast-and-select (B&S) architecture already present in prior art reconfigurable optical add/drop multiplexers (ROADMs).

In one or more example embodiments of the present invention may include additional features and functionality, such as for example optical channel extension provisioning and/or optical channel extension tear-down that may be dynamic and/or automated, and such automation may be based on an adjustable target level of transmission resiliency that can be dynamically (e.g., on-demand) or statically set by a network operator using network operator inputs for example, and such automation may be accomplished by a network controller or management system that, for example, may receive network operator inputs.

In one or more example embodiments of the present invention, a given optical channel extension may be established for example at or around the time a given provisioned optical data channel path is newly established, and/or a given optical channel extension may be removed for example at or around the time a given provisioned optical data channel path is torn down.

In one or more example embodiments of the present invention, a network controller or management system provides a network operator the opportunity to flexibly, granularly, and dynamically during network operation, establish, remove (i.e., tear-down), and/or otherwise manage optical channel extensions in the optical network, whether as individual optical channel extensions and/or as one or more groups of optical channel extensions. This may be accomplished for example using network operator inputs to the system.

In one or more example embodiments of the present invention, a network planning tool, whether as a component functionality of a network controller or management system or instead as a stand-alone tool, provides a network planner the opportunity to design and/or otherwise plan optical channel extensions for the optical network in advance of optical channel extension deployment. Once again, this may be accomplished for example using network operator inputs to the system.

In one or more example embodiments of the present invention, a network planning tool, or Path Computation Element (PCE) of a Software-Defined Networking (SDN) controller, or other network controller or management system, or another component accessible to any of the foregoing, operates to identify and/or manage suitable optical channel extension opportunities in the optical network to achieve a desired target level of transient-resiliency. Such optical channel extension opportunities can be maintained for example as part of a light-tree that identifies both optical data channels and related optical channel extensions for a given optical network.

In one or more example embodiments of the present invention, a given optical channel extension is provisioned proactively so as to occupy, in a static and ongoing manner, at least a portion of target link spectral resources that are determined to be unoccupied by a provisioned optical data channel.

In one or more example embodiments of the present invention, a given optical channel extension is provisioned reactively, so as to occupy at least a portion of target link spectral resources that are determined to be unoccupied immediately after a transient trigger event is detected.

FIGS. 1, 2 and 4 show an example optical network 100, and more specifically, an optical WDM network. While network controller or management system 160 is depicted in only one of these three figures (namely, FIG. 1), it will be understood that network controller or management system 160 similarly serves a role in the context of each of these other figures as well. Optical network 100 comprises four nodes, namely nodes 102, 104, 106 and 108, with a fiber optic link 122 spanning node pairs 102 and 104, a fiber optic link 124 spanning node pairs 104 and 108, and a fiber optic link 126 that spans node pairs 104 and 106. Each of fiber optic links 122, 124 and 126 is established by at least one optical fiber cable. EDFAs 112 and 114 are located along the fiber optic link 124, such that a first span 124-A of fiber optic link 124 extends between node 104 and EDFA 112, a second span 124-B of fiber optic link 124 extends between EDFA 112 and EDFA 114, and a third span 124-C of fiber optic link 124 extends between EDFA 114 and node 108.

Each of nodes 102, 104, 106 and 108 can switch optical data channels between different ingress and egress degrees of the respective node. In the context of this example optical network 100, a given optical data channel is provisioned, using a network controller and/or management system 160 for example, to extend between two end nodes—i.e., from a first (e.g., source) node in the network to a second (e.g. destination) node in optical network 100 through one or more links of optical network 100 and, if a plurality of links, through intervening node 104 of optical network 100 that serves to interconnect the plurality of links along the provisioned path (i.e., the provisioned optical data channel path). As a result, the provisioned optical data channel path establishes an optical channel (i.e., the provisioned optical data channel) for optical data communications (e.g., client traffic) between the first node and the second node.

These first and second nodes, and any other intervening node (e.g., node 104, if applicable) that may also serve to establish the provisioned optical data channel path, for convenience shall be hereinafter referred to as provisioned path nodes (for the given optical data channel). With respect to each of the provisioned path nodes, each ingress and/or egress of a given provisioned path nodes that is employed to establish the provisioned optical data channel path is deemed to be a part of the provisioned optical data channel path, whereas the provisioned optical data channel path shall not be deemed to include any other ingress or egress of these provisioned path nodes that is not used to establish the provisioned optical data channel path. In at least certain example embodiments, a given provisioned optical data channel path is further established by and comprises applicable local add and/or drop port(s) (of the provisioned path end nodes) that is/are employed to respectively add or drop the corresponding optical data channel.

Each provisioned optical data channel is allocated a respective wavelength (i.e., frequency) slot (for convenience, hereinafter “wavelength”) in each of the one or more links of the provisioned optical data channel path. In general, each link in an optical WDM network with an arbitrary topology (e.g., mesh) is capable of being traversed by multiple optical data channels using a different wavelength for each data channel.

In a first optical network configuration and/or a first normal operational state of this particular optical network 100 shown in the figures herein, wherein optical network 100 is operating for example without the benefit of an example embodiment of the present invention or other alternative transient-resiliency mechanism, a total of five optical data channels 502, 504, 512, 514 and 518 are present in optical network 100. FIG. 4, for example, illustrates such a first configuration and/or first normal operational state, wherein optical data channel 502 is provisioned to extend from node 102 to node 108 through node 104, such that each of nodes 102, 104 and 108 are provisioned path nodes for purposes of the provisioned optical data channel path for provisioned optical data channel 502. The provisioned optical data channel path for provisioned optical data channel 502 comprises nodes 102, 104 and 108, and links 122 and 124. Optical data channel 504 is provisioned to extend from node 102 to node 104, such that each of nodes 102 and 104 are provisioned path nodes for purposes of the provisioned optical data channel path for provisioned optical data channel 504. The provisioned optical data channel path for provisioned optical data channel 504 comprises nodes 102 and 104, and link 122. Optical data channel 512 is provisioned to extend from node 106 to node 108 through node 104, such that each of nodes 106, 104 and 108 are provisioned path nodes for purposes of the provisioned optical data channel path for provisioned optical data channel 512. The provisioned optical data channel path for provisioned optical data channel 512 comprises nodes 106, 104 and 108, and links 126 and 124. Optical data channel 514 is provisioned to extend from node 106 to node 104, such that each of nodes 106 and 104 are provisioned path nodes for purposes of the provisioned optical data channel path for provisioned optical data channel 514. The provisioned optical data channel path for provisioned optical data channel 514 comprises nodes 106 and 104, and link 126. Optical data channel 518 is provisioned to extend from node 104 to node 108, such that each of nodes 104 and 108 are provisioned path nodes for purposes of the provisioned optical data channel path for provisioned optical data channel 518. The provisioned optical data channel path for provisioned optical data channel 518 comprises nodes 104 and 108, and link 124. Optical data channels that are provisioned to extend to node 108 also pass through EDFAs 112 and 114, and therefore the respective provisioned optical data channel paths associated with these particular optical data channels further include EDFAs 112 and 114.

Still in relation to FIG. 4, provisioned optical data channel 502 is graphically depicted by graphs 500 and 520, while provisioned optical data channel 504 is graphically depicted by graph 500. Provisioned optical data channel 512 is graphically depicted by graphs 510 and 520, while provisioned optical data channel 514 is graphically depicted by graph 510. Provisioned optical data channel 518 is graphically depicted by graph 520. In each of graphs 500 (i.e., a power profile at a given location on link 122), 510 (i.e., a power profile at a given location on link 126) and 520 (i.e., a power profile at a given location on span 124-A), the x-axis 508 represents frequency, while y-axis 506 represents optical power. Graph 520 graphically depicts provisioned optical data channels 502, 512 and 518 as they exist at the given location on span 124-A of link 124, in this example first optical network configuration and/or first normal operational state of optical network 100. Each of provisioned optical data channels 502, 504, 512 and 518 are communicated in all of their respective links at substantially the same optical power level, again for simplicity in the illustration.

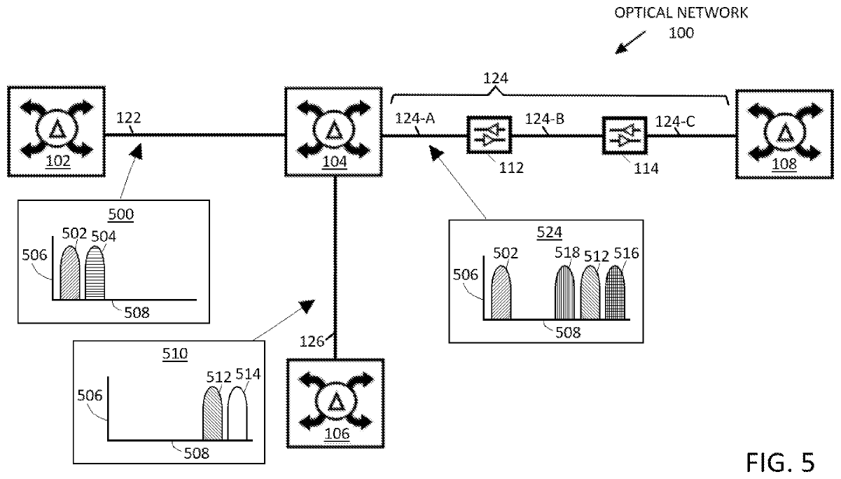

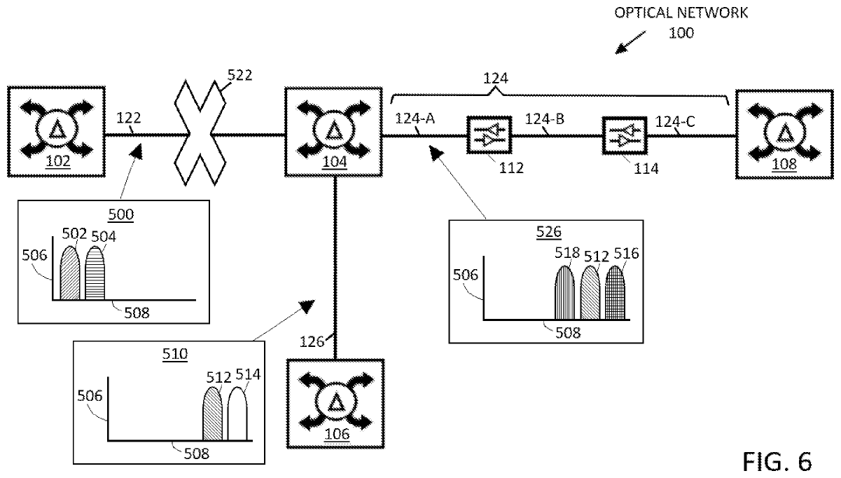

In anticipation of the discussion below in relation to FIGS. 5 and 6, but still in relation to the optical network 100 described above in relation to FIG. 4, it shall be assumed for simplicity of the example description herein, but without loss of generality, that in the event such optical network 100 of FIG. 4 were to suffer a transient trigger event, any resulting QoT degradation experienced by any surviving channels on surviving link 124 would rise to the level of adversely service-affecting QoT degradation only if thirty percent (30%) or more of the optical spectral resources employed on link 124 prior to the transient trigger event are lost as a result of the transient trigger event.

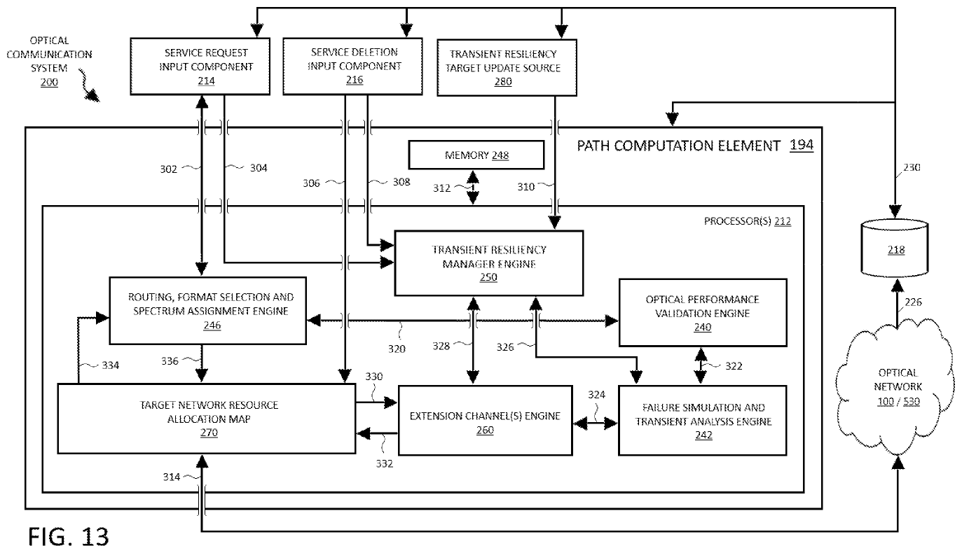

FIG. 5, in contrast to FIG. 4, depicts a second optical network configuration and/or a second normal operational state of optical network 100, wherein optical network 100 is now configured and operating as an example embodiment of the present invention. FIG. 5 differs from FIG. 4 insofar as example embodiment optical network 100 of FIG. 5 employs optical channel extension 516 that is provisioned to extend from node 104 to node 108 through link 124 (including EDFAs 112 and 114 of link 124). This presence of optical channel extension 516 in the optical spectral resources traversing link 124 is reflected for example in graph 524 (i.e., a power profile at the given location on span 124-A) of FIG. 5. In this example embodiment, optical channel extension 516 is introduced into the optical network by node 104, as will be further described below including in relation to FIG. 3, with additional support from an example embodiment network controller or management system (not shown in FIGS. 5 and 6) as will be further described below in relation to FIGS. 13-18.

In particular, node 104 for example is configured to use provisioned optical data channel 514 from link 126 to establish optical channel extension 516 for link 124, by expressing provisioned optical data channel 514 to link 124 as optical channel extension 516. In this regard, optical channel extension 516 is the optical spectral resources of provisioned optical data channel 514 expressed by node 104 through to link 124. The frequency slot position of optical channel extension 516 in its power profile 524 therefore is the same frequency slot position of provisioned optical data channel 514 in its corresponding link power profile 510.

Notwithstanding this direct relationship between optical channel extension 516 and provisioned optical data channel 514, optical channel extension 516 nevertheless is illustrated in FIG. 5 using a different fill pattern (in power profile 524) as compared to the illustration of provisioned optical data channel 514 (in power profile 510), simply for purposes of clarity for example in distinguishing in the figures optical spectral resources comprising an optical data extension in relation to a given link, versus those optical spectral resources comprising, in relation to another link, a provisioned optical data channel from which the optical data extension derives. Again for purposes of clarity, other figures similarly use power profile fill pattern differences to help distinguish a given optical data channel from the corresponding provisioned optical data channel from which the optical channel extension derives.

FIG. 6 again depicts the same second optical network configuration and/or a second normal operational state of optical network 100 as does FIG. 5, wherein optical network 100 is configured and operating as an example embodiment of the present invention. FIG. 6 differs from FIG. 5 insofar as example embodiment optical network 100 is shown in FIG. 6 as incurring a transient trigger event 522, such as a fiber cut for example, on link 122. Transient trigger event 522 results in the total loss of provisioned optical data channel 502 in downstream link 124. Optical channel extension 516, however, serves to help stabilize the surviving optical data channels 512 and 518 traversing surviving link 124, as reflected for example in graph 526 (i.e., power profile at the given location on span 124-A) of FIG. 6.

Indeed, the presence of optical channel extension 516 operates to prevent a service-affecting QoT degradation of surviving provisioned optical data channels 512 and 518 traversing surviving link 124, insofar as the working assumption for purposes of the example description herein, as explained above and as applied to optical network 100 of FIGS. 5 and 6, is that any resulting QoT degradation experienced by any surviving provisioned optical data channels communicating on surviving link 124 rises to the level of adversely service-affecting QoT degradation only if thirty percent (30%) or more of the optical spectral resources become absent in link 124 as a result of the transient trigger event. For purposes of optical network 100 of FIGS. 5 and 6, a loss of only one of the optical data channels (i.e., optical data channel 502) among the optical spectral resources shown in graph 524 (FIG. 5) would not be enough of a loss to cause a service-affecting QoT degradation of surviving provisioned optical data channels 512 and 518 traversing surviving link 124. In this example, the continuing presence in surviving link 124 of optical channel extension 516, notwithstanding the absence of provisioned optical data channel 502, serves to avoid the above-described service-impacting loss of thirty percent (30%) or more of the optical spectral resources employed on link 124 prior to the transient trigger event.

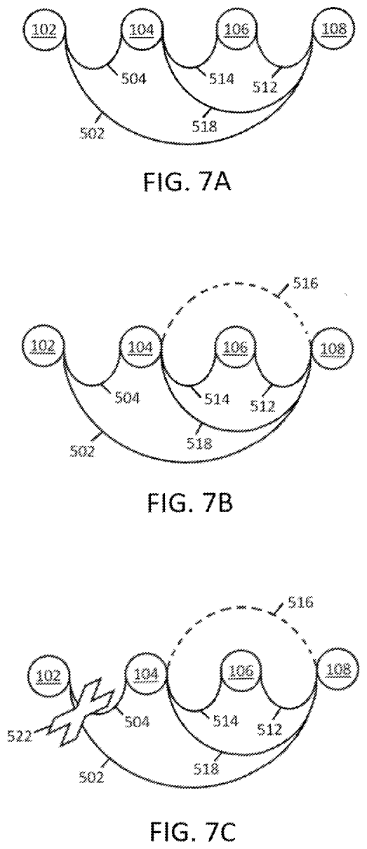

FIG. 7A is a schematic representation of the various nodes of the example optical network 100 shown in FIG. 4, and the various provisioned optical data channels that extend between respective node pairs—i.e., source node (or provisioned path source node) and destination node (or provisioned path destination node) of the corresponding provisioned optical data channel path—in the representative example first optical network configuration and/or a first normal operational state. FIG. 7B is a schematic representation of the example embodiment optical network 100 of FIG. 5 in the representative example second optical network configuration and/or a second normal operational state, including the example optical channel extension 516. FIG. 7C is a schematic representation of the example embodiment optical network 100 of FIG. 6 in its depicted example state of failure, indicated by the ‘X’. Dotted line 516 represents, in FIGS. 7B and 7C, the presence of optical channel extension 516 in optical network 100, in accordance with this example embodiment of the present invention. Note that none of FIG. 7A, 7B or 7C purport to depict or indicate which ones of nodes 102, 104, 106 and 108 are provisioned path nodes belonging to a given provisioned optical data channel path or corresponding provisioned optical data channel, other than the provisioned path source node and provisioned path destination node. Note that each of FIG. 7A, 7B or 7C schematically depicts only end node pairs for each given provisioned optical data channel or given provisioned optical channel extension of example optical network 100.

In the example embodiment optical network 100 described above in relation to FIGS. 5 and 6, the architecture of at least node 104 is at least generally consistent with the example embodiment node 400 shown in FIG. 3. FIG. 3 illustrates a representative optical network node 400, and in particular a reconfigurable optical add-drop multiplexer (ROADM) 400 in accordance with an example embodiment of the present invention. ROADM 400 is a four-degree broadcast-and-select-style (B&S) ROADM, wherein its first degree is represented by degree ingress 412 and degree egress 416, its second degree is represented by degree ingress 432 and degree egress 436, its third degree is represented by degree ingress 452 and degree egress 456, and its fourth degree is represented by degree ingress 472 and degree egress 476. A total of m local ports 486-1 through 486-m serve as a local interface 486 for purposes of local adding and/or dropping of select optical data channels. In this way, optical data channels may locally ingress or locally egress the node 400. While ROADM 400 is illustrated and described as a four-degree ROADM 400, example node 104 of example optical network 100 is preferably at least a three-degree ROADM, if not a four-degree ROADM (wherein one of the four degrees may for example remain idle in optical network 100), having a similar broadcast-and-select architecture.

Each degree of the ROADM 400 is configured to interface with a given optical link of an optical WDM network into which ROADM 400 is deployed, and is established at least in part by both a respective one of ingress optical splitters 410, 430, 450 and 470, and a respective one of egress Wavelength Selective Switches (WSSs) 420, 440, 460 and 480. In this regard, each of ingress optical splitters 410, 430, 450 and 470 corresponds with a respective degree ingress 412, 432, 452 and 472, and each of egress WSSs 420, 440, 460 and 480 corresponds with a respective degree egress 416, 436, 456 and 476.

This particular example embodiment incorporates ingress optical splitters 410, 430, 450 and 470, rather than ingress WSSs that are often instead used in alternative prior art WSS-based ROADM architectures, for at least a couple of reasons. First, optical splitters are, generally speaking, significantly less costly to procure than WSSs, in the inventors' experience. Second, insofar as WSSs typically employ filters that can have an adverse impact on optical signal performance, the choice of an ingress optical splitter, rather than an ingress WSS, can help reduce the overall adverse impact that filtering components collectively have on the optical signal performance of the node. Moreover, ingress optical splitters are particularly well-suited for broadcast and select functionality of the sort described herein. That said, the inventors do recognize that the use of optical splitters might present certain other node- or network-related challenges, such as for example higher crosstalk values that a B&S architecture might exhibit due to the architecture's single-stage, rather than multi-stage, filtering. It might also be appropriate or necessary to use higher amplifier gain values to offset higher insertion losses that optical splitters might present as compared to WSSs. Such use of higher amplifier gain values in turn, might for example in turn increase ASE noise to a level that might require additional noise management to achieve a particular level of optical transmission performance in the network.

Each of ingress optical splitters 410, 430, 450 and 470 is configured to receive an optical WDM signal received by node 400 at its respective one of degree ingresses 412, 432, 452 and 472 with which the respective ingress optical splitter 410, 430, 450 or 470 corresponds, and to in turn communicate, or broadcast, that received optical WDM signal to at least a select one or more, if not all, of egress WSSs 420, 440, 460 and 480 and drop ports that may be among local ports 486-1 through 486-m. One or more optical splitter outputs of the given ingress optical splitter are used to in this way communicate, or broadcast, the received optical WDM signal to the aforementioned one or more other ROADM components, through intra-ROADM light paths. For example, ingress optical splitter 410 comprises n optical splitter outputs 414, each individually identified and referenced in FIG. 3 as one of outputs 414-1 through 414-n. Ingress optical splitter 430 similarly comprises n optical splitter outputs 434. Ingress optical splitter 450 similarly comprises n optical splitter outputs 454. Ingress optical splitter 470 similarly comprises n optical splitter outputs 474. For simplicity of the drawing, example intra-ROADM light paths and/or other prior art ROADM details known to those skilled in the art of ROADM technologies are not depicted in FIG. 3. If a degree loopback functionality is desired to establish a loopback optical channel extension, the one or more egress WSSs 420, 440, 460 and 480 to which the received optical WDM signal is communicated, or broadcast, may therefore necessarily include the egress WSSs associated with the degree egress that pairs with the degree ingress, through which the optical WDM signal was received by node 400, to form a given one of the four degrees of the ROADM. Further, it will be understood that although example three- and four-degree ROADM embodiments have been shown and/or described herein, the present invention is also applicable for example to ROADM embodiments having a different—e.g., larger—number of degrees.

The architecture and configuration of node 400 enables node 400 to receive, at a given degree ingress, among degree ingresses 412, 432, 452 and 472, an optical WDM signal communicated to the given degree ingress of node 400, and to in turn use a select egress WSS, among egress WSSs 420, 440, 460 and 480, to selectively express a given provisioned optical data channel, of the received optical WDM signal, out of node 400, through the degree egress which corresponds to the select egress WSS, so as to further communicate downstream the provisioned optical data channel-either as the provisioned optical data channel communicating along another downstream link of the provisioned optical data channel path, or as an optical channel extension communicating downstream of node 400. This select egress WSS WDM-multiplexes such expressed provisioned optical data channel together with any other spectrally non-overlapping optical channels egressing node 400 at the same degree egress (potentially including for example one or more additional provisioned optical data channels and/or optical channel extensions established for purposes of such downstream link). WSSs 420, 440, 460 and 480 each operate to block those components of the optical WDM signal, as well as any add-port signal or other signal, that are not to egress node 400 at the respective corresponding degree egress. Note that it is also within the scope of at least certain example optical-network embodiments of the present invention that a given optical channel extension that is communicated out of node 400 through a given degree egress, as described by this paragraph, is in turn similarly further communicated by one or more downstream nodes to one or more optical network link(s) downstream of such one or more downstream nodes.

If example node 400 is for example a destination node of a provisioned optical data channel path for the provisioned optical data channel described by the foregoing paragraph, then node 400 is for example configured to direct the provisioned optical data channel to a drop port of node 400 among local ports 486-1 through 486-m, and to not express the provisioned optical data channel out of node 400 through any other degree egress of node 400, except for one or more degree egresses of node 400 for the purpose of using the provisioned optical data channel to respectively establish one or more optical channel extensions for one or more downstream links of the optical network that extend from node 400, if there is a determined need for such optical channel extension(s). In this way, example node 400 may be employed for example to communicate a respective optical channel extension out each of two or more node 400 egresses using a single provisioned optical data channel.

If node 400 is not a destination node of a provisioned optical data channel path for the provisioned optical data channel described above, then node 400 is configured to express the provisioned optical data channel out of node 400 through a degree egress of node 400 (or a plurality of degree egresses, for example for multicast and/or point-to-multipoint applications) so as to further communicate downstream the provisioned optical data channel along another link (or a plurality of links that branch from node 400, for example for multicast and/or point-to-multipoint applications) of the provisioned optical data channel path. Furthermore, if in this non-destination node example there is a determined need for an optical channel extension on another link (i.e., a link that does not belong to the aforementioned provisioned optical data channel path) that extends from another degree egress of node 400, then example node 400 may be further configured to also express the provisioned optical data channel out of node 400 through such another degree egress of node 400 for the purpose of using the provisioned optical data channel to establish an optical channel extension for such another link. Indeed, in this way the provisioned optical data channel can be used by node 400 to establish an optical channel extension on each of one or more links that extend from node 400.

One or more example embodiments contemplate adding the functionality of the present invention to prior art B&S ROADMs and/or optical networks that employ prior art B&S ROADMs. One or more of such example embodiments may for example deploy ROADM control of the sort described herein to prior art B&S ROADMs in the form of new or updated control software, so as to thus enable such ROADMs to newly function in a manner consistent with the present invention.

In one or more example embodiments of the present invention, node 400 is instead, or additionally, configured to communicate a given optical channel extension to optical network 100 by communicating through, to a node degree egress, an optical data channel that locally ingresses node 400 through local interface 486, rather than by expressing a provisioned optical data channel of an optical WDM signal received at one of the degree ingresses, as described above. One or more of these example embodiments might also broadcast this locally received optical data channel to one or more other node degree egresses, using for example another optical splitter (not shown) in association with local interface 486, as a provisioned optical data channel and/or optical channel extension for another link of the optical network served by node 400.

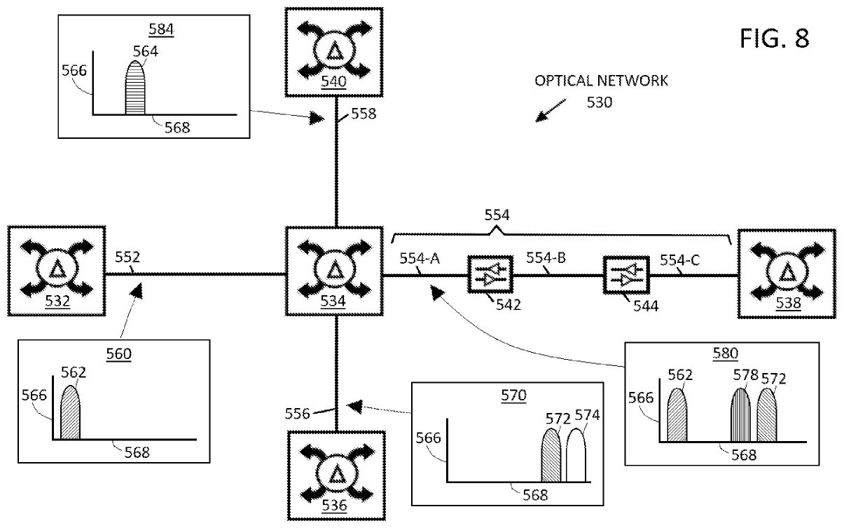

FIG. 8 shows an example optical network 530, and more specifically, an optical WDM network. Optical network 530 is generally similar to previously discussed optical network 100, although optical network 530 further comprises a fifth node, node 540, and related link 558. While a network controller or management system is not depicted, it will be understood that a network controller or management system (not shown) similarly serves a role in the context of optical network 530. Optical network 530 comprises five nodes, namely nodes 532, 534, 536, 538 and 540, with a fiber optic link 522 spanning node pairs 532 and 534, a fiber optic link 554 spanning node pairs 534 and 538, a fiber optic link 556 that spans node pairs 534 and 536, and a fiber optic link 558 that spans node pairs 534 and 540. Each of fiber optic links 522, 554, 556 and 558 is established by at least one optical fiber cable. EDFAs 542 and 544 are located along the fiber optic link 554, such that a first span 554-A of fiber optic link 554 extends between node 534 and EDFA 542, a second span 554-B of fiber optic link 554 extends between EDFA 542 and EDFA 544, and a third span 554-C of fiber optic link 554 extends between EDFA 544 and node 538.

Each of nodes 532, 534, 536, 538 and 540 can switch optical data channels between different degree ingresses and degree egresses of the respective node. In the context of this example optical network 530, a given optical data channel is provisioned, using a network controller and/or management system (not shown) for example, to extend between two end nodes—i.e., from a first (e.g., source) node in the network to a second (e.g. destination) node in optical network 530 through one or more links of optical network 530 and, if a plurality of links, through intervening node 534 of optical network 530 that serves to interconnect the plurality of links along the provisioned path (i.e., the provisioned optical data channel path). As a result, the provisioned optical data channel path establishes an optical channel (i.e., the provisioned optical data channel) for optical data communications (e.g., client traffic) between the first node and the second node.

These first and second nodes, and any other intervening node (e.g., node 534, if applicable) that may also serve to establish the provisioned optical data channel path, for convenience shall be hereinafter referred to as provisioned path nodes (for the given optical data channel). With respect to each of the provisioned path nodes, each ingress and/or egress of a given provisioned path nodes that is employed to establish the provisioned optical data channel path is deemed to be a part of the provisioned optical data channel path, whereas the provisioned optical data channel path shall not be deemed to include any other ingress or egress of these provisioned path nodes that is not used to establish the provisioned optical data channel path. In at least certain example embodiments, a given provisioned optical data channel path is further established by and comprises applicable local add and/or drop port(s) (of the provisioned path end nodes) that is/are employed to respectively add or drop the corresponding optical data channel.

Each provisioned optical data channel is allocated a respective wavelength (i.e., frequency) slot (for convenience, hereinafter “wavelength”) in each of the one or more links of the provisioned optical data channel path. In general, each link in an optical WDM network with an arbitrary topology (e.g., mesh) is capable of being traversed by multiple optical data channels using a different wavelength for each data channel.

In a first optical network configuration and/or a first normal operational state of this particular optical network 530 shown in the figures herein, wherein optical network 530 is operating for example without the benefit of an example embodiment of the present invention or other alternative transient-resiliency mechanism, a total of five optical data channels 562, 564, 572, 574 and 578 are present in optical network 530. FIG. 8, for example, illustrates such a first configuration and/or first normal operational state, wherein optical data channel 562 is provisioned to extend from node 532 to node 538 through node 534, such that each of nodes 532, 534 and 538 are provisioned path nodes for purposes of the provisioned optical data channel path for provisioned optical data channel 562. The provisioned optical data channel path for provisioned optical data channel 562 comprises nodes 532, 534 and 538, and links 522 and 554. Optical data channel 564 is provisioned to extend from node 540 to node 534, such that each of nodes 540 and 534 are provisioned path nodes for purposes of the provisioned optical data channel path for provisioned optical data channel 564. The provisioned optical data channel path for provisioned optical data channel 564 comprises nodes 540 and 534, and link 558. Optical data channel 572 is provisioned to extend from node 536 to node 538 through node 534, such that each of nodes 536, 534 and 538 are provisioned path nodes for purposes of the provisioned optical data channel path for provisioned optical data channel 572. The provisioned optical data channel path for provisioned optical data channel 572 comprises nodes 536, 534 and 538, and links 556 and 554. Optical data channel 574 is provisioned to extend from node 536 to node 534, such that each of nodes 536 and 534 are provisioned path nodes for purposes of the provisioned optical data channel path for provisioned optical data channel 574. The provisioned optical data channel path for provisioned optical data channel 574 comprises nodes 536 and 534, and link 556. Optical data channel 578 is provisioned to extend from node 534 to node 538, such that each of nodes 534 and 538 are provisioned path nodes for purposes of the provisioned optical data channel path for provisioned optical data channel 578. The provisioned optical data channel path for provisioned optical data channel 578 comprises nodes 534 and 538, and link 554. Optical data channels that are provisioned to extend to node 538 also pass through EDFAs 542 and 544, and therefore the respective provisioned optical data channel paths associated with these particular optical data channels further include EDFAs 542 and 544.

Still in relation to FIG. 8, provisioned optical data channel 562 is graphically depicted by graphs 560 and 580, while provisioned optical data channel 564 is graphically depicted by graph 584. Provisioned optical data channel 572 is graphically depicted by graphs 570 and 580, while provisioned optical data channel 574 is graphically depicted by graph 570. Provisioned optical data channel 578 is graphically depicted by graph 580. In each of graphs 560 (i.e., a power profile at a given location on link 522), 570 (i.e., a power profile at a given location on link 556) and 580 (i.e., a power profile at a given location on span 554-A), the x-axis 568 represents frequency, while y-axis 566 represents optical power. Graph 580 graphically depicts provisioned optical data channels 562, 572 and 578 as they exist at the given location on span 554-A of link 554, in this example first optical network configuration and/or first normal operational state of optical network 530. Each of provisioned optical data channels 562, 564, 572, 574 and 578 are communicated in all of their respective links at substantially the same optical power level, again for purposes of simplicity in illustration.

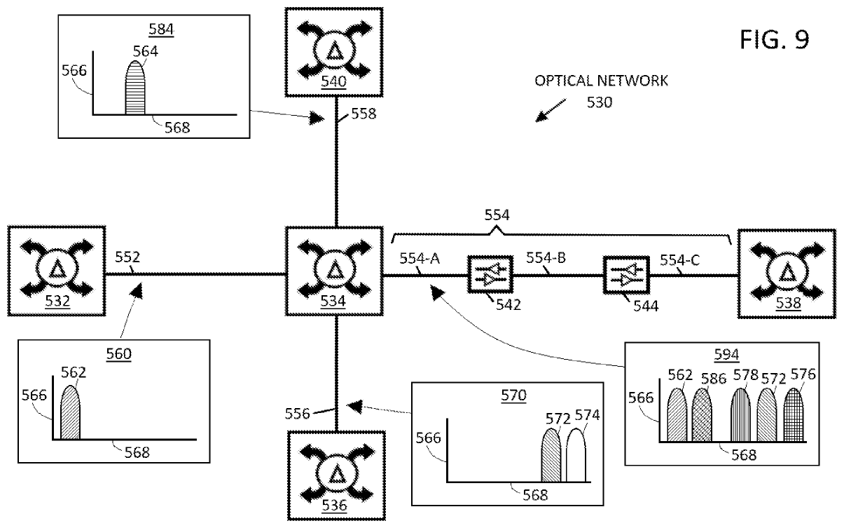

FIG. 9, in contrast to FIG. 8, depicts a second optical network configuration and/or a second normal operational state of optical network 530, wherein optical network 530 is now configured and operating as an example embodiment of the present invention. FIG. 9 differs from FIG. 8 insofar as example embodiment optical network 530 of FIG. 9 employs optical channel extensions 576 and 586 that are each provisioned to extend from node 534 to node 538 through link 554 (including EDFAs 542 and 544 of link 554). This presence of optical channel extensions 576 and 586 in the optical spectral resources traversing link 554 is reflected for example in graph 594 (i.e., a power profile at the given location on span 554-A) of FIG. 9. In this example embodiment, optical channel extensions 576 and 586 are introduced into the optical network by node 534, in a similar manner as described above in relation to FIG. 3, with additional support from an example embodiment network controller or management system (not shown in the figures) as will be further described below for example in relation to FIGS. 13-18. In particular, node 534 for example is configured to use provisioned optical data channel 574 from link 556 to establish optical channel extension 576 for link 554. Node 534 is for example also configured to use provisioned optical data channel 564 from link 558 to establish optical channel extension 586 for link 554. Optical channel extensions 576 and 586 are provisioned to extend from node 534 to node 538 through link 554.

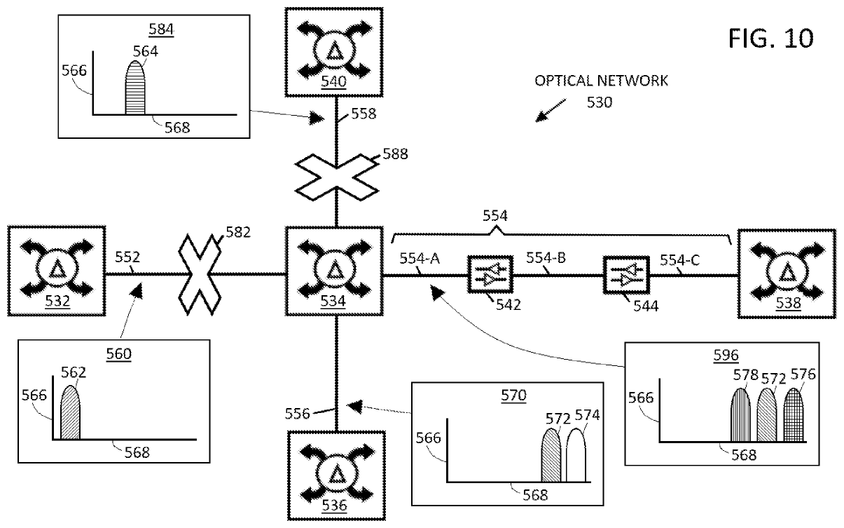

FIG. 10 again depicts the same second optical network configuration and/or a second normal operational state of optical network 530 as does FIG. 9, wherein optical network 530 is configured and operating as an example embodiment of the present invention. FIG. 10 differs from FIG. 9 insofar as example embodiment optical network 530 is shown in FIG. 10 as incurring one transient trigger event 582 on link 522, and another transient trigger event 588 on link 558. Transient trigger event 582 results in the total loss of provisioned optical data channel 562 in downstream link 554, while transient trigger event 588 results in the total loss of provisioned optical data channel 564 at node 534. This loss of provisioned optical data channel 564 at node 534 in turn results in a loss on link 554 of optical channel extension 586, which node 534 originally established using provisioned optical data channel 564. However, surviving optical channel extension 576, which node 534 originally established using provisioned optical data channel 574 (which still survives), nevertheless serves to help stabilize the surviving provisioned optical data channels 572 and 578 traversing surviving link 554, as reflected for example in graph 596 (i.e., a power profile at the given location on span 554-A) of FIG. 10. Indeed, the continuing presence of optical channel extension 576 preferably operates to sufficiently stabilize optical spectral resources on link 554 so as to prevent a service-affecting QoT degradation of surviving provisioned optical data channels 572 and 578 traversing surviving link 554.

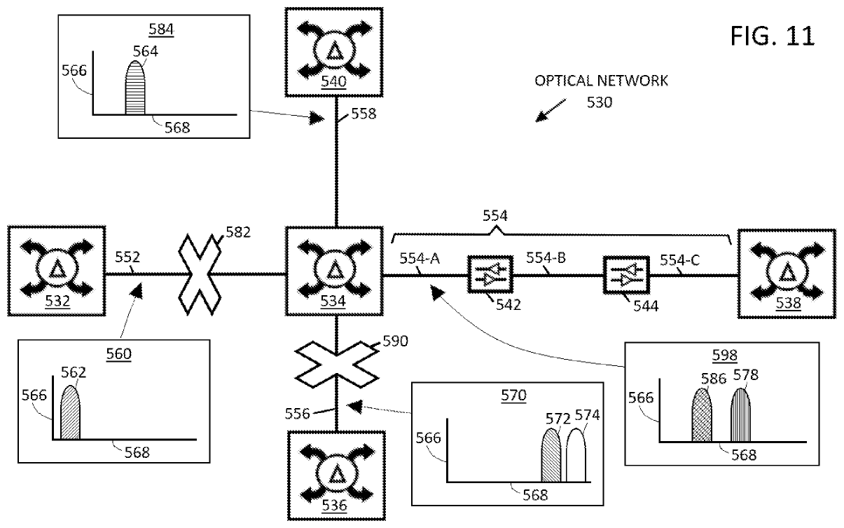

FIG. 11 again depicts the same second optical network configuration and/or a second normal operational state of optical network 530 as does FIG. 9, wherein optical network 530 is configured and operating as an example embodiment of the present invention. FIG. 11 differs from FIG. 9, and from FIG. 10 for that matter, insofar as example embodiment optical network 530 is shown in FIG. 11 as now incurring one transient trigger event 582 on link 522, and another transient trigger event 590 on link 556. Transient trigger event 582 results in the total loss of provisioned optical data channel 562 in downstream link 554, while transient trigger event 590 results in the total loss of provisioned optical data channels 572 and 574 at node 534. This loss of provisioned optical data channel 574 at node 534 in turn results in a loss on link 554 of optical channel extension 576, which node 534 originally established using provisioned optical data channel 574. However, surviving optical channel extension 586, which node 534 originally established using provisioned optical data channel 564 (which still survives), nevertheless serves to help stabilize the surviving provisioned optical data channel 578 traversing surviving link 554, as reflected for example in graph 598 (i.e., a power profile at the given location on span 554-A) of FIG. 11. Indeed, the continuing presence of optical channel extension 586 preferably operates to sufficiently stabilize optical spectral resources on link 554 so as to prevent a service-affecting QoT degradation of surviving provisioned optical data channel 578 traversing surviving link 554.

In the example embodiment optical network 530 described above in relation to FIGS. 9, 10 and 11, at least node 534 is consistent with the example embodiment ROADM 400 shown in FIG. 3 and described above. Like node 400, node 534 is depicted in optical network 530 as having four degrees.

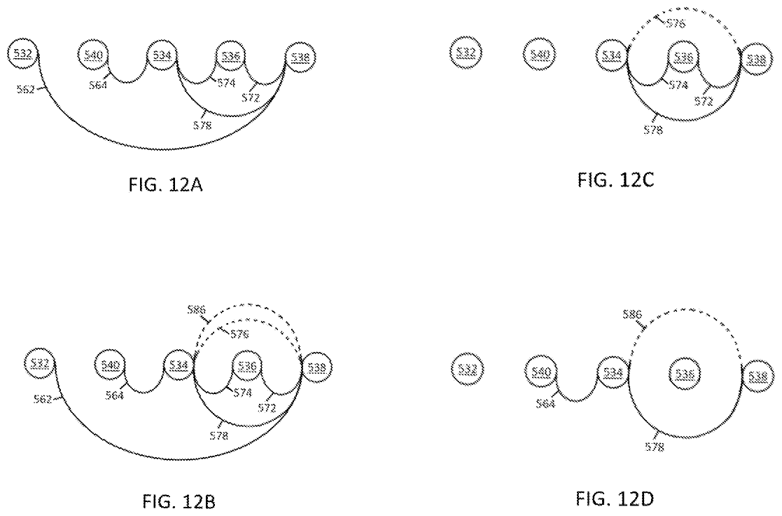

FIG. 12A is a schematic representation of the various nodes of the example optical network 530 shown in FIG. 8, and the various provisioned optical data channels that extend between respective node pairs—i.e., source node (or provisioned path source node) and destination node (or provisioned path destination node) of the corresponding provisioned optical data channel path—in the representative example first optical network configuration and/or a first normal operational state. FIG. 12B is a schematic representation of the example embodiment optical network 530 of FIG. 9 in the representative example second optical network configuration and/or a second normal operational state, including the example optical channel extensions 576 and 586. FIG. 12C is a schematic representation of the example embodiment optical network 530 of FIG. 10 in its depicted example state of double failure, each indicated by an ‘X’. FIG. 12D is a schematic representation of the example embodiment optical network 530 of FIG. 11 in its depicted example state of double failure, each indicated by an ‘X’. In FIGS. 12B, 12C and/or 12D, dotted line 576 represents the presence of optical channel extension 576 in optical network 530, and dotted line 586 represents the presence of optical channel extension 586 in optical network 530, each in accordance with this example embodiment of the present invention in its given respective state as described above. Note that each of FIGS. 12A, 12B, 12C and 12D schematically depicts only end node pairs for each given provisioned optical data channel or given provisioned optical channel extension of example optical network 530. Also note that in FIGS. 12C and 12D, unlike FIG. 7C, do not purport to schematically illustrate those provisioned optical data channels and corresponding provisioned optical data channel paths that are lost due to the afore-mentioned failures in the network.

FIG. 13 schematically illustrates an example optical communication system 200 in accordance with one or more example embodiments. In optical communication system 200, a Path Computation Element (PCE) 194 is configured to orchestrate, implement, execute, and manage transient resilient transmissions in an optical network, such as for instance optical network 100 as shown and described in relation to FIGS. 5 and 6, and optical network 530 as shown and described in relation to FIGS. 9-11. Optical communication system 200 represents an example baseline provisioning system that supports, among other aspects of network operation, the development, establishment, management, and removal of optical channel extensions for improved optical network transient resilience. Preferably, example optical communication system 200 is configured to employ one or more target level(s) of transient resilience to administer such transient resiliency in the optical network. In one or more of such example embodiments, one or more of such target level(s) may be for example one or more of the following: static (e.g., unchanging and/or not adjustable); dynamic (e.g, changing and/or adjustable); predetermined; pre-established; network-operator determined, established and/or otherwise administered, whether statically or on-demand; and automatically determined, established and/or otherwise administered.

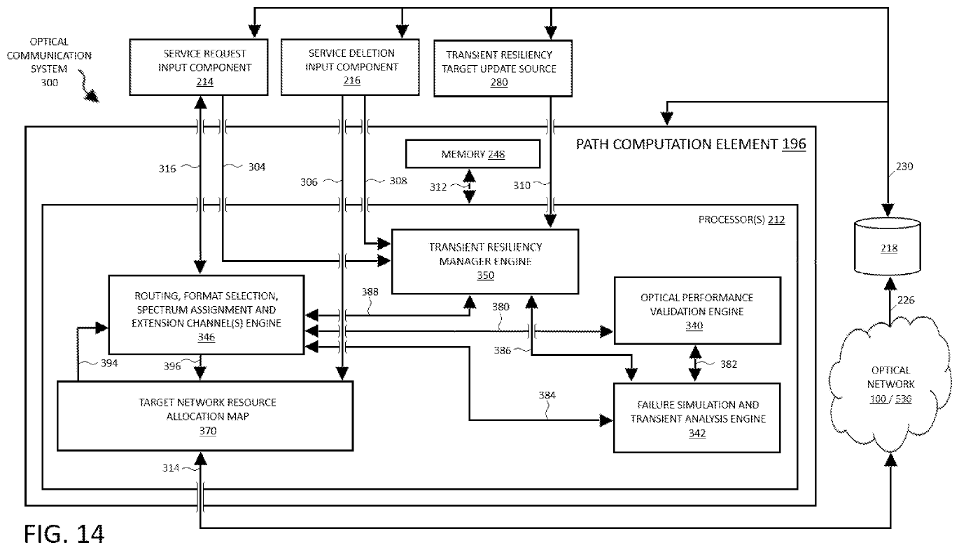

While the schematic illustrations of FIG. 13, and FIGS. 14-18 for that matter, each might not depict all fundamental aspects, components and functionalities that those of ordinary skill typically or traditionally associate with prior art network provisioning systems, such fundamental aspects, components and/or functionalities are already known to those of ordinary skill in the art and therefore will be understood to be within the scope of the various example optical communication systems and other example embodiments shown in any of the figures and/or otherwise described herein.

With reference to example optical network 100 as shown and described in relation to FIGS. 5 and 6, and optical network 530 as shown and described in relation to FIGS. 9-11, for example, PCE 194 is, in one or more example embodiments of optical communication system 200, configured to improve transient resiliency of optical spectral resources in each of link 124 (as shown and described above for example in relation to FIGS. 5 and 6) and link 554 (as shown and described above for example in relation to FIGS. 9-11). In this example, PCE 194 is an example embodiment network controller or management system (not specifically depicted in FIGS. 5 and 6, nor in FIGS. 9-11), or component thereof, that communicates with optical network 100/530 so as to control/manage optical network 100/530 consistent with the present invention as respectively described for example in relation to FIGS. 5 and 6, and 9-11. FIG. 13 schematically shows PCE 194 communicatively coupled to optical network 100/530, Service Request Input Component (SRIC) 214, Service Deletion Input Component (SDIC) 216, Transient Resiliency Target Update Source (TRTUS) 280, in accordance with one or more example embodiments. For example, the PCE 194 is shown as receiving a service request 302, 304 from SRIC 214. In response to receiving the service request 302, 304 PCE 194 may generate one or multiple provisioning instructions 314. For example, PCE 194 establishes and communicates provisioning instructions 314 to the optical network 100/530, so as to for example establish, manage, and/or delete (i.e., remove) one or more optical data channels and/or one or more corresponding provisioned optical data channel paths in optical network 100/530. PCE 194 also establishes and communicates provisioning instructions 314 to the optical network 100/530, so as to for example establish, manage, and/or delete (i.e., remove) one or more optical channel extensions in optical network 100/530, in accordance with one or more example embodiments of the present invention.

The optical network 100/530 may transmit optical network information 226 to Data Monitoring Component (DMC) 218, which in turn may transmit network update information 230 to any one or more, if not all, of PCE 194, SRIC 214, SDIC 216, and TRTUS 280. In certain example embodiments, optical network information 226 and/or network update information 230 may for example indicate current state(s) of, and any internal in and/or to, optical network 100/530. In certain example embodiments, optical network information 226 and/or network update information 230 may instead or additionally provide further indications relating any one or more of the following: performance or other operation; topology; network resources such as for example components, functionalities, and technologies; and any other information regarding optical network 100/530 that may for example improve or facilitate the use of optical channel extensions in example embodiment optical network 100/530, in accordance with the present invention.

Consistent with traditional prior art network controllers/management systems, the arrival of a service request 302 and/or 304 at PCE 194 triggers the Routing, Format Selection and Spectrum Assignment Engine (RFSSAE) 246, which is responsible for allocating suitable resources (comprising optical spectral resources, or spectrum, for example with respect to any one or more optical data channels and/or optical channel extensions relating to service request 302, 304). This RFSSAE 246 interacts with an Optical Performance Validation Engine (OPVE) 240 to ensure that a given proposed provisioning assignment is optically feasible.

In this example embodiment, at least four main actions can, either alone or in combination, trigger PCE 194: (1) the arrival of one or more service request(s) 302, 304; (2) the arrival of one or more deletion orders 306, 308, to delete one or more service(s); (3) a determined need to perform a transient resiliency target update (as may be indicated for example by target update indicator 310), and (4) an update from DMC 218. Furthermore, any of the foregoing actions can, either alone or in combination, result in PCE 194 making: (a) one or more changes in or relating to any of the one or more transient resiliency target(s) that PCE 194 employs in the administration of the transient resiliency of optical network 100/530; and/or (b) one or more other changes adjustments in how PCE 194 administers transient resiliency, for example in view of new or changed service, provisioning, or administrative needs, targets, requirements, deployments, availabilities and/or opportunities relating to optical network 100/530. These needs, targets, requirements, deployments, availabilities and/or opportunities may for example relate (directly or indirectly) to any one or more of: optical spectral resources (whether provisioned, or not yet provisioned, or previously provisioned and since deleted or removed, either in whole or in part), including for example optical data channel(s) and/or optical channel extension(s); network performance; network operation; network topology: other network resources such as components, functionalities or technologies; and/or alternative or supplemental transient mitigation technologies deployed in optical network 100/530.

Transient Resiliency Manager Engine (TRME) 250 is the component of this example embodiment that is primarily responsible to establish and otherwise manage the current and future levels of target transient resiliency used by optical communication system 200 to improve transient resiliency of optical network 100/530. To accomplish this, TRME 250 interacts with each of Failure Simulation and Transient Analysis Engine (FSTAE) 242 and Extension Channel(s) Engine (ECE) 260.

FSTAE 242 is the component of this example embodiment that is primarily responsible for estimating the anticipated impact (e.g., via simulations) that one or more possible transient trigger events in optical network 100/530 will have to the optical network 100/530, particularly for example in terms of the respective performance impact(s) that any resulting power transients may have on the provisioned optical data channels that survive the transient trigger event. FTSE 242 can also interact with OPVE 240 to estimate such impact(s) more accurately.

ECE 260 is the component primarily responsible to determine appropriate optical channel extensions for deployment in optical network 100/530, in accordance with the present invention. To that end, ECE 260 receives updated information regarding at least a current target spectrum allocation in optical network 100/530, which is for example stored as a Target Network Resource Allocation Map (TNRAM) 270. Information stored for example as TNRAM 270 may also comprise for example the optical spectrum, or optical spectral resources, to be allocated in the provisioning of new optical data channels, and/or the optical spectral resources to be released by the deletion of previously established provisioned optical data channels. Moreover, ECE 260 interacts with TRME 250 so as to receive information regarding the transient resiliency target(s) associated with one or more services, and to communicate back to TRME 250 updated transient resiliency target values/attributes relating to the optical channel extensions determined by ECE 260. ECE 260 can interact directly with FSTAE 242. Alternatively, ECE 260 can instead, or additionally, interact indirectly with FSTAE 242 via TRME 250, and as may be mediated by TRME 250. The optical channel extensions determined by ECE 260, and validated by TRME 250, are fed into TNRAM 270 (or another map/database of network resources) for example as optical channel extension assignments or instructions, from where they can be read for purposes of communicating configurations to optical network 100/530, for example including in particular configurations for respective nodes or other network elements or components (e.g., WSSs or similar filtering/switching devices in ROADMs) that are necessary or appropriate to implement the determined optical channel extensions.

In certain example embodiments, transient resiliency target(s) can be determined or set or adjusted, at least in part, by a network operator using network operator inputs to the system. In certain example embodiments, transient resiliency target(s) can be determined or set or adjusted, at least in part, by the system in an autonomous manner. In certain example embodiments, transient resiliency target(s) can be determined or set or adjusted, at least in part, in a dynamic and/or static manner. In certain example embodiments, transient resiliency target(s) can be determined or set or adjusted, at least in part, by a combination of the foregoing.

Similarly, a deletion order 306, 308 to delete one or more service(s) also triggers the above-described provisioning workflow for at least two important reasons. First, for example, a given deletion order will result in the deletion of the provisioned optical data channel resources that correspond to the deletion order, removing those particular optical spectral resources from the corresponding portion(s) of the optical network. Such removal of these optical spectral resources in turn alters the respective power profiles at those network locations, such as for example nodes and link(s), where such removed optical spectral resources were present prior to such removal. This change in one or more power profiles across the optical network represents changed circumstances for the network and the various remaining provisioned optical data channels that remain in the optical network. This changed circumstance likely, if not certainly, alone warrants a re-evaluation of the post-deletion transient resiliency status of and needs for the optical network, including at least related transient resilient targets and optical channel extension configurations. Additionally, however, such a re-evaluation is further warranted from the perspective that a given deletion order not only gives rise to a deletion of the provisioned optical data channel resources that directly correspond to the deletion order, but the deletion order also necessarily results in or otherwise gives rise to an absence or removal of any network-deployed optical channel extensions that were based on any of these now-removed provisioned optical data channel resources. A going-forward absence of such optical channel extensions(s), including optical spectral resource contributions these optical channel extension(s) were providing to certain power profiles of the network and, as a result, to the transient resiliency of the network, therefore is also a changed circumstance that likely, if not certainly, only further warrants such a re-evaluation of the post-deletion transient resiliency status of and needs for the optical network. Ongoing re-evaluations of this sort serve to help ensure that target transient resiliency values associated with continuing services are still met. This exercise of re-evaluation may result for example in the deployment of newly established optical channel extensions and/or new optical channel extension configurations based on those optical spectral resources that remain in the network, depending for example on the nature of any other changed service or other network circumstances that may have arisen in addition to the deletion order.

Preferably, PCE 194 is configured so as to allow PCE 194 to make its optical channel extension determinations independently of other resource allocation determinations for which PCE 194 is also responsible, such as for example determinations relating to optical data channel routing, format selection and spectrum assignment. Moreover, PCE 194 is also preferably configured to make its optical channel extension determinations after PCE has first made such other resource allocation determinations. Such sequential order of determinations by PCE helps to prevent the optical channel extension determinations from unduly influencing the other resource allocation determinations.

Optical communications system 300 illustrated by FIG. 14 represents another example optical communications system embodiment that can be viewed as an alternative to the example implementation of FIG. 13. Optical communications system 300 mimics the overall structure and functionality of optical communications system 200 in most every respect as shown and described above, including for example at each of the various components and communication flows of optical communications system 300 that in FIG. 14 bear the same name or illustrate the same or similar communication flow as corresponding components or communication flows of optical communications system 200 as shown and described above in relation to FIG. 13, despite the different, unique reference numerals to which such components and communication flows are assigned in FIG. 14, as compared to reference numerals of FIG. 13. That said, in optical communications system 300, a single engine, namely Routing, Format Selection, Spectrum Assignment and Extension Channel(s) Engine (RFSSAECE) 346, is instead configured to perform the optical spectral resource allocation of both (a) the optical data channels, and (b) the optical channel extensions (i.e., the functionality performed by ECE 260 in optical communications system 200). Accordingly, RFSSAECE 346 of optical communications system 300 represents the combined functionalities of RFSSAE 246 and ECE 260 of optical communications system 200, and thus also now inherits the inter-component communication flows that each of RFSSAE 246 and ECE 260 is shown as having with each other and with other components of FIG. 13. By performing both of these optical spectral resource allocation functions (which, according to at least certain example embodiments of example optical communications system 300, can be performed jointly—e.g., together in a combined process, in contrast to the sequential process described above in relation to optical communication system 200), RFSSAECE 346 may improve efficiency in the identification of transient resiliency solutions that for example result in more efficient optical network operation and/or enable higher levels of transient resiliency.

The below example scenario is described with reference again to the example embodiment shown and described with respect to FIGS. 5 and 6. In this example scenario, a request is made and received, by the Path Computation Element of the applicable optical communication system (e.g., 200 or 300), to provision a new service/optical data channel between nodes 104 and 108. In turn, the Path Computation Element (the PCE) operates to determine the optical spectral resources to be assigned and used by the requested optical data channel. Assume for the sake of this example scenario that the PCE simultaneously, in the case of optical communication system 300 for example, or afterwards, in the case of optical communication system 200 for example, further determines that an optical channel extension should be established, between nodes 104 and 108, to meet a given target transient resiliency relating to link 124. In this regard, the PCE operates to assign the newly requested service/optical data channel to optical data channel 518, and to provision a new optical channel extension comprising optical channel extension 516, as shown in FIGS. 5 and 6. In this example scenario, optical channel extension 516 between nodes 104 and 108 is again an optical channel extension of optical data channel 514 between nodes 106 and 104.

A given optical channel extension in the example embodiments of the present invention shown and described above is deployed into the network for the purpose of transient resiliency, rather than in support of the delivery of optical data communication (e.g., client traffic) service(s) associated with the optical data channel from which the given optical channel extension derives, even though such optical channel extension comprises the optical data channel (and thus the optical data communications thereof) from which it derives. The fact that optical channel extensions in the example embodiments of the present invention occupy optical spectral resources that otherwise could instead be provisioned for the delivery of optical data communication service(s) may prove acceptable in for example light- to medium-load optical network conditions, where demand for optical spectral resources for optical data communication service(s) can be reasonably met notwithstanding the presence of optical channel extensions in the network (e.g., the presence of such optical channel extensions does not unreasonably inhibit or prevent the successful provisioning of new optical data channels). However certain embodiments of the present invention may be implemented for example such that at higher-load conditions, wherein for example optical spectral resources in one or more links may become sufficiently scarce such that the presence of optical channel extensions does inhibit or prevent the successful provisioning of new optical data channels, or presents material risk of such inhibiting or prevention, the administration of optical channel extensions in accordance with this example embodiment of the present invention treats the occupation of optical spectral resources by optical channel extensions as a soft spectrum reservation. In this regard, when the system for example operates to newly provision a given optical data channel using optical spectral resources that conflict in whole or in part with optical spectral resources occupied by a given provisioned optical extension channel, the system can operate to tear down such optical channel extension (e.g., by reconfiguring the applicable ROADM egress WSS such that it blocks or otherwise inhibits the corresponding ROADM egress from continuing to communicate such optical channel extension). In this way for example, the system may release optical channel extension spectrum in favor of new optical data channel spectrum. This functionality (e.g., of determining which conflicting provisioned optical channel extensions should be released, or discarded, to the exclusion of other provisioned optical channel extensions) can be performed for example by TRME 250/350, which for example can implement policies and establish thresholds that define the trade-off between releasing more spectrum in favor of provisioning new optical data channels (via the elimination of certain existing provisioned optical channel extensions in the network) versus maintaining a given level of transient resiliency in the network.

Each example PCE is preferably configured for example to enforce various Service Level Agreements (SLAs) that may relate to the provisioned services, which such SLAs for example may influence the nature and/or provisioning of optical channel extensions in the network. For example, a greater relative number of optical channel extensions may be deployed in network links traversed by one or more optical data channel(s) that have one or more strict SLAs, as compared to a fewer relative number of optical channel extensions that may be deployed in network links traversed by one or more optical data channels that have one or more relaxed SLAs. Moreover, the SLAs of provisioned optical data channels will, in the example preferred embodiments disclosed herein, also play a role in setting priorities for purposes of determining which optical channel extensions can be removed, or can be removed before other optical channel extensions, to release spectrum for new optical data channels. In other words, in making a determination as to which of two provisioned optical channel extensions to release in favor of a new optical data channel, the PCE may be configured to first release the provisioned optical channel extension of the two that supports one or more other optical data channels that individually, or in the aggregate, associate with a more relaxed SLA as compared to an individual or aggregate SLA that the other of the two optical channel extensions supports.

Each example PCE preferably can also support optical restoration scenarios in a spectrally efficient manner. Optical restoration is usually slower than protection mechanisms, and is often used as a complement for protection mechanisms rather than a replacement of protection mechanisms (hereinafter, protection). For instance, once a failure occurs, protection is typically used to help ensure hitless or quasi-hitless failure recovery, whereas optical restoration typically is then used to pre-provision an alternative solution in case a second failure occurs that can impact the protection path and associated resources. To maximize the chances of successfully finding restoration solutions, specific optical channel extensions can be quickly torn down, releasing spectrum that can be instead used to set up restoration channels. TRME 250/350 may be tasked for example with identifying which optical channel extensions can be compromised for the purpose of setting up restoration channels, and which optical channel extensions cannot be compromised in this manner. Note that restoration channels are typically only temporary in nature and, therefore, it can be acceptable for example to prioritize a present and urgent need for restoration channels to address one or more actual failures, over the need for transient resiliency against other, merely potential future failures in the network. Once the cause of such actual failure(s) is identified and fixed, services are expected to return to normal such that services again route over the pre-failure optical data channels, and the pre-failure extension channels can also be reinstated.

FIGS. 13 and 14 disclose example embodiment proactive provisioning systems, which primarily focus on setting up optical channel extensions during normal network operation in anticipation of/preparation for future transient trigger events. The optical channel extensions are present in the network and occupy optical spectral resources both during normal network operation and after a transient trigger event (e.g., failure) takes place, except for example for those optical channel extensions that may traverse the transient trigger event location (e.g., failed network segment), or which are optical channel extensions that are based on an optical data channel that traverses the transient trigger event location (e.g., failed network segment).

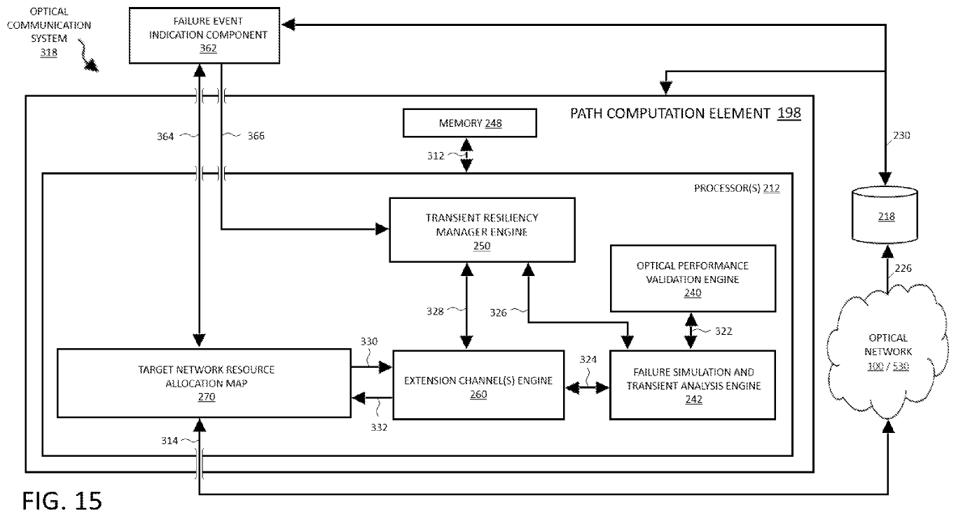

FIG. 15, by contrast, discloses an example embodiment reactive provisioning system that supports reactive determination and deployment of one or more extension channels for network operation with improved transient resiliency, wherein for example optical channel extensions are provisioned reactively, in response to for example an identified or suspected occurrence of a transient trigger event, and/or in response to a detected transient or other identified characteristic(s) present in the network that indicate(s) or suggest(s) the occurrence of a transient trigger event, in an effort to quickly fill gaps in the power profile (in whole or at least in part) that arise as a result of such a transient trigger event. In this regard, the optical channel extensions are not present in one or more portions, if not the entirety, of the optical network during normal network operation. In the event of a given transient trigger event scenario, a reactive provisioning system such as this example embodiment can be triggered (e.g., after each of any one or more of the foregoing transient trigger event scenarios, on a per-transient-trigger-event basis, or triggered as otherwise may be desired based on network and/or transient resiliency needs or constraints, for example).

Once the example reactive provisioning system is so triggered, in at least one example embodiment of the reactive provisioning system the Transient Resiliency Manager Engine 250 interacts with both the Extension Channel(s) Engine 260 and the Failure Simulation and Transient Analysis Engine 242 to determine, based on the surviving optical data channels, the suitable optical channel extensions that should be provisioned in optical network 100/530 to mitigate the impact of resulting transients. In this regard, it preferably operates with an aim of quickly filling most, if not all, gaps in the power profile that arise as a result of the transient trigger event. After the result of the determination becomes available, a command is issued to each of the required WSSs (or alternative devices) to, for example, unblock signal propagation such that the select optical data channel(s) now extend beyond their provisioned optical data channel path(s) so as to establish in optical network 100/530 the determined target optical channel extension(s).

In at least another example embodiment of the reactive provisioning system, the Transient Resiliency Manager Engine 250 has already pre-determined (i.e., in advance of a given transient trigger event) the suitable optical channel extensions that should be, once the given transient trigger event arises, provisioned in optical network 100/530 to mitigate the impact of resulting transients. A principal advantage of this example embodiment is that the turn-around, or reaction, time—i.e., the period of time between those moments in time when for example a transient trigger event is detected and when the suitable optical channel extensions are deployed in optical network 100/530—may be reduced, perhaps meaningfully so.

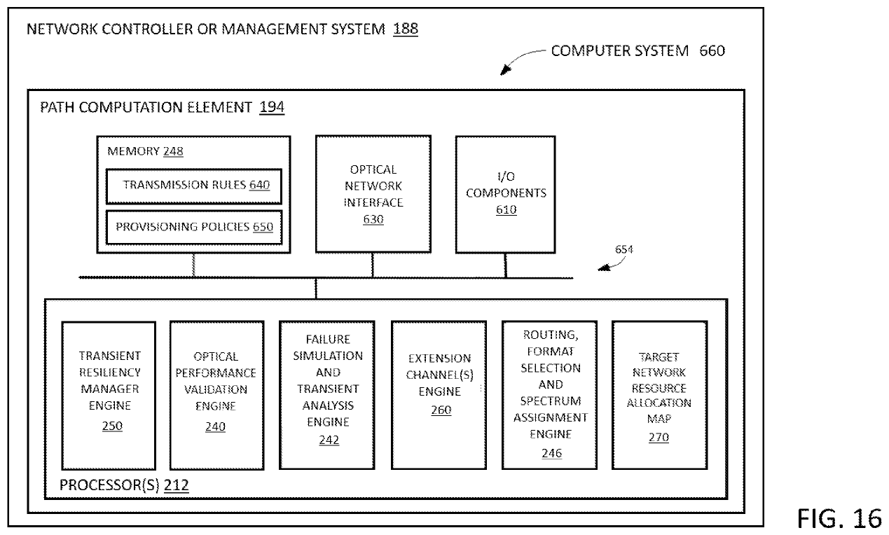

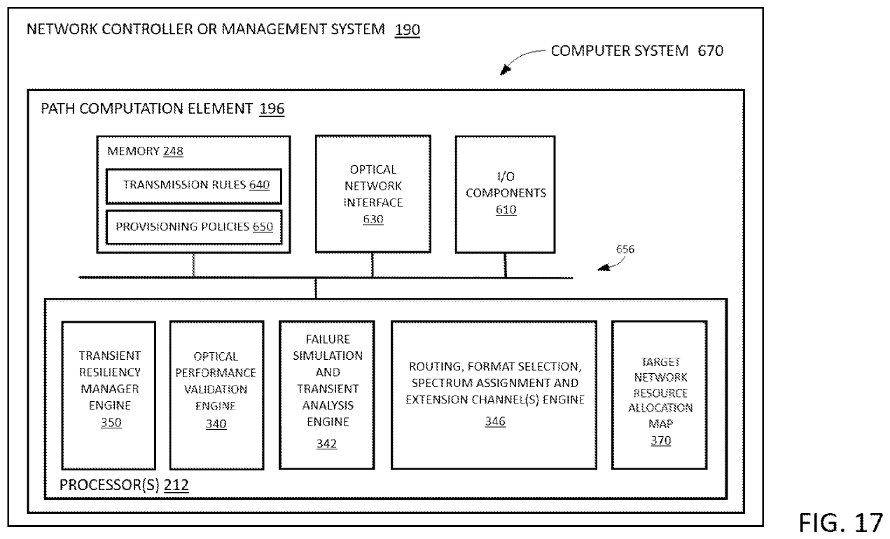

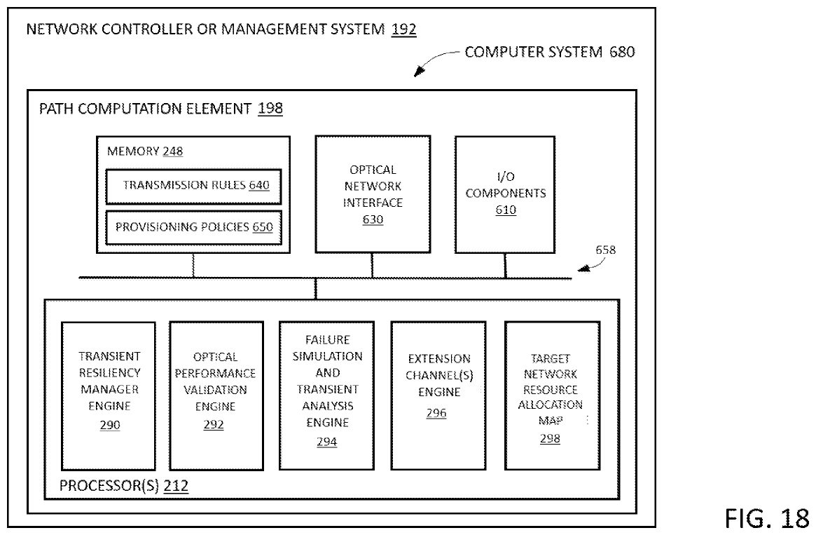

FIGS. 16-18 each respectively illustrate an example embodiment of a computer system 660 (FIG. 16), 670 (FIG. 17) and 680 (FIG. 18) respectively shown in FIGS. 13, 14, and 15 (hereinafter computer system 660/670/680), including the respective PCE 194 (FIG. 16), 196 (FIG. 17) and 198 (FIG. 18) (hereinafter PCE 194/196/198). Each computer system 660/670/680 is an example embodiment configured to improve transient resiliency in optical network 100/530 by adaptively provisioning instructions for routing resources in optical network 100/530. In one or more example embodiments, each computer system 660/670/680 may be any system that is configured to process data and interact with the optical network 100/530. Examples of each computer system 660/670/680 include, but are not limited to, a personal computer, a desktop computer, a workstation, a server, a laptop, a tablet computer, or any other suitable type of device.

In each computer system 660/670/680, the respective PCE 194/196/198 may include one or more Input (I)/Output (O) components 610, such as a display, a microphone, a camera, keypad, port, or other appropriate terminal equipment usable to receive input/output signaling (such as for example a service request from service request input component 214, a deletion order from service deletion input component 216, and/or a target update indicator from TRTUS 280), and/or input/output from/to a network operator. The PCE 194/196/198 may include the one or more processors 212, the memory 248, and/or circuitry (not explicitly shown) configured to perform one or more of the functions or actions of the computer system 660/670/680 described herein. For example, a software application designed using software code may be stored in the memory 248 and executed by the one or more processors 212 to perform the functions of the computer system 660/670/680. The computer system 660/670/680 is configured to communicate with devices and components of the optical network 100/530 (not shown in FIGS. 16-18).

The PCE 194/196/198 may include the one or more processors 212 communicatively coupled with at least certain of the I/O components 610 and an optical network interface 630. Further, the one or more processors 212 may include one or more processors communicatively coupled to the memory 248. The one or more processors 212 may be one or more electronic circuitries, including, but not limited to, state machines, one or more central processing unit (CPU) chips, logic units, cores (e.g., one or more multi-core processors), field-programmable gate array (FPGAs), or application-specific integrated circuits (ASICs). For example, the one or more processors 212 may be implemented in cloud devices, servers, virtual environments, and the like. The one or more processors 212 may be a programmable logic device, a microcontroller, a microprocessor, or one or more suitable combination of the preceding. The one or more processors 212 are configured to process data and may be implemented in hardware or software. In some example embodiments, the one or more processors 212 is coupled to the I/O components 610 via a system bus, such as for example respective system bus 654 (FIG. 16), 656 (FIG. 17) and 658 (FIG. 18). The one or more processors 212 may be further coupled to an optical network interface 630 via the same respective system bus. The one or more processors 212 may communicate with other elements of the optical network 100/530 via the optical network interface 630, such as, for example, network nodes. The one or more processors 212 may include an internal clock (not shown) to keep track of time, periodic time intervals, and the like.

In the example embodiment of FIG. 13, the one or more processors 212 is configured for example to perform one or more of the functions described in reference to TRME 250, OPVE 240, FSTAE 242, ECE 260, RFSSAE 246 and TNRAM 270. In the example embodiment of FIG. 14, the one or more processors 212 is configured for example to perform one or more of the functions described in reference to TRME 350, OPVE 340, FSTAE 342, RFSSAECE 346 and TNRAM 370. In the example embodiment of FIG. 15, the one or more processors 212 is configured for example to perform one or more of the functions described in reference to TRME 290, OPVE 292, FSTAE 294, ECE 296 and TNRAM 298.

Those skilled in the art will readily understand from this disclosure that in many instances throughout this disclosure, the phrase “the one or more processors 212”—as used for example in reference to a given one of the various disclosed implementations or configurations associated with “the one or more processors 212”-shall not be construed so as to necessarily require, in an example embodiment that employs a plurality of processors 212, that every one of such plurality of processors 212 associate with the given implementation or configuration. In example embodiments that comprise one or more processors 212, for example, each one of such one or more processors 212 might not be used to implement each of the above-described engines. Indeed, such given implementation or configuration of an engine may instead associate with only a given one processor, or a given subset of processors, among such plurality of processors 212 that an example embodiment comprises. Moreover, such given one processor, or subset of processors, may be the same as, or different in whole or in part from, a processor or subset of processors, among such plurality of processors 212, that may associate with another given one of the various engines or other disclosed implementations or configurations that associate with “the one or more processors 212.”

The example optical network interface 630 is configured to enable wired and/or wireless communications with one or more devices in the optical network 100/530. The optical network interface 630 may be configured to communicate data between the PCE 194/196/198 and other devices, systems, or domains. For example, the optical network interface 630 may comprise for example and without limitation a NFC interface, a Bluetooth interface, a Zigbee interface, a Z-wave interface, a radio-frequency identification (RFID) interface, a WIFI interface, a LAN interface, a WAN interface, a MAN interface, a PAN interface, a WPAN interface, a modem, a switch, and/or a router.

The example memory 248 may have a computer-readable medium communicatively coupled to the one or more processors 212, for example via the respective system bus 654, 656 or 658 of FIGS. 16-18. Memory 248 is used by the one or more processors 212 to store and read/write data, as well as computer program instructions used to implement the procedure(s) and functions described herein and shown in the accompanying drawing(s). Memory 248 may be used by the one or more processors 212 to store other types of data, such as, by example only, network-related information, as described above. In operation, the one or more processors 212 may load the program instructions into the memory 248. The one or more processors 212 then may execute the loaded program instructions to perform one or more of the example procedures described herein, for operating the example PCE 194/196/198. In some example embodiments, memory 248 may for example further include one or more transmission rules 640 and one or more provisioning policies 650, as shown for example in FIGS. 16-18.

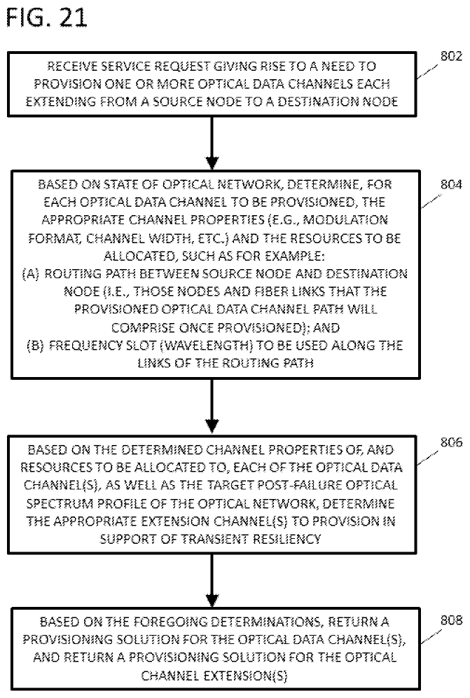

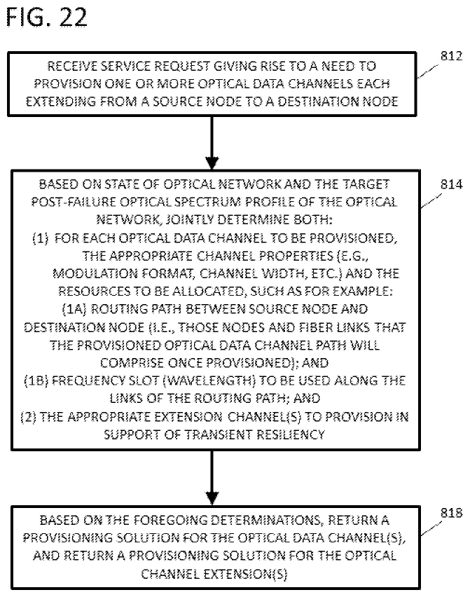

Example methods of determining one or more suitable extension channels to provision are shown for example in FIGS. 21 and 22. In these examples, such determinations are made as a component of the process of provisioning one or more new optical data channels for the optical network.

FIG. 21, for example, illustrates a first example method comprising steps 802, 804, 806 and 808, that for instance is suitable for optical communication system 200. Recall that optical communication system 200 is described above for example as first determining optical spectral resources for one or more optical data channels, and thereafter determines optical spectral resources for one or more optical channel extensions, as is reflected in sequential steps 804 and 806. The key decisions for provisioning a given optical data channel usually include for example the channel properties, the routing path to be used (i.e., determining what will become the provisioned optical data channel path), and the frequency slot allocated in the links of that path. Other resources may include the local add/drop ports used and other equipment at the path end nodes. The decisions for provisioning optical channel extensions depend on the provisioned optical data channels, since they are bound to reuse the frequency slots of the latter.

FIG. 22, for example, illustrates a second example method comprising steps 812, 814 and 818, that for instance is suitable for optical communication system 300. Recall that optical communication system 300 is described above for example as jointly determining optical spectral resource allocation of both the optical data channels and the optical channel extensions, as is reflected in step 814. In this example embodiment, this joint determination may yield more optimized transient resiliency solutions, given the fact that the provisioning of a given optical channel extension in this jointly determined resource allocation method does not necessarily depend on previously provisioned optical data channel path and frequency slot/wavelength used by the given optical data channel from which the optical channel extension is established, in contrast to such sequential dependency that necessarily results in the first example method of FIG. 21. Notably, the effectiveness and reusability potential of the optical channel extensions themselves can be improved if for example the spectrum assignment of a given optical data channel already accounts for transient resiliency impact of the optical channel extensions that can be derived from the optical data channel. In at least certain example embodiments for instance, each potential spectrum assignment solution that can be considered by RFSSAECE 346 is weighted, as a secondary cost metric, by the network-wide improvement in transient resiliency arising from the optical channel extensions enabled by the spectrum assignment solution.

1. A system, comprising:
at least one processor configured to provision an optical channel extension in an optical network, using a provisioned optical data channel; and
a memory communicatively coupled with the at least one processor and configured to store computer program instructions that, when executed by the at least one processor, operate to provision the optical channel extension.

2. The system of claim 1, wherein the operation to provision the optical channel extension is based at least in part on one or more network operator inputs to the system.
